(19) United States
(12) Patent Application Publication
(10) Pub. No.: US 2011/0282670 A1
(43) Pub. Date: Nov. 17, 2011

(54) System for Dynamic AD Selection and Placement Within a Voice Application Accessed Through an Electronic Information Page

(75) Inventors: Leo Chiu, South San Francisco, CA (US); Peter Loukianoff, Oakland, CA (US)

(73) Assignee: Apptera, Inc., Sunnyvale, CA (US)

(21) Appl. No.: 12/943,827

(22) Filed: Nov. 10, 2010

Related U.S. Application Data
(63) Continuation of application No. 11/132,840, filed on May 18, 2005, now abandoned.
Application No. 11/132,840 is a continuation-in-part of application No. 11/059,970, filed on Feb. 16, 2005, now abandoned.
Application No. 11/132,840 is a continuation-in-part of application No. 10/803,851, filed on Mar. 17, 2004, now Pat. No. 7,609,829.
Application No. 11/132,840 is a continuation-in-part of application No. 11/072,062, filed on Mar. 3, 2005, now abandoned.
(60) Provisional application No. 60/651,603, filed on Feb. 9, 2005.
(60) Provisional application No. 60/652,161, filed on Feb. 10, 2005.
(60) Provisional application No. 60/619,295, filed on Oct. 14, 2004.
(60) Provisional application No. 60/581,924, filed on Jun. 21, 2004.
(60) Provisional application No. 60/523,042, filed on Nov. 17, 2003.

(51) Int. Cl. G10L 15/00

(52) U.S. Cl. 704/270; 704/E15.001

(57) ABSTRACT

A system for dynamic advertisement selection and presentment within a speech application is provided. The system includes a user operable network browsing interface in communication with a server on a data network; at least one voice link to a voice application interface, the link or links accessible to the user working within the browsing interface; a pool of at least one advertisement for presentment; and a selection engine accessible to the voice application interface for receiving criteria originated from the server for advertisement ranking and for selecting an advertisement from the pool of at least one advertisement for placement based on the received criteria.

### CROSS-REFERENCE TO RELATED APPLICATIONS

The present application is a Continuation of co-pending U.S. patent application Ser. No. 11/132,840, filed on May 18, 2005, the disclosure of which is incorporated by reference herein. That application claims priority to provisional application Ser. No. 60/651,603, filed on Feb. 8, 2005, and also claims priority to provisional application Ser. No. 60/652,161, filed on Feb. 10, 2005, and also claims priority as a CIP to US non-provisional patent application Ser. No. 11/059,970, filed on Feb. 16, 2005 which claims priority to provisional application Ser. No. 60/619,295, filed Oct. 14, 2004. U.S. patent application Ser. No. 11/132,840 also claims priority to U.S. provisional patent application Ser. No. 60/581,924, filed on Jun. 21, 2004, and also claims priority as a CIP to U.S. non-provisional patent application Ser. No. 10/803,851, filed on Mar. 17, 2004 which claimed priority to provisional application Ser. No. 60/523,042 filed Nov. 17, 2003. U.S. patent application Ser. No. 11/132,840 is also a continuation in part application to U.S. non-provisional patent application Ser. No. 11/072,062, filed on Mar. 3, 2005. The disclosure of all of the above-referenced applications are incorporated by reference herein.

### BACKGROUND OF THE INVENTION

1. Field of the Invention

The present invention is in the area of voice application software systems and pertains particularly to methods and a system for enabling dynamic selection and presentment of content and keyword or phrase relevant voice dialog, including advertisements within a voice application accessed from an electronic information interface.

2. Discussion of the State of the Art

With the relatively recent advent of voice extensive markup language (VXML) the expertise required to develop a speech application solution has been reduced somewhat. VXML is a language that enables a software developer to focus on the application logic of the voice application without being required to configuring underlying telephony components. Typically, the developed voice application is run on a VXML interpreter that resides on and executes on the associated telephony system to deliver the voice solution. Likewise, other voice-enabling markups like speech application language tagging (SALT) and J-speech markup language (JSML) may be used in place of VXML.

A typical architecture of a VXML-compliant telephony system comprises a voice application server and a VXML-compliant telephony server. To develop and deploy a typical VXML voice application, an application database is created or an existing one is modified to support VXML. Application logic is provided and is designed in terms of workflow and is adapted to handle the routing operations of the delivery system. A VXML rendering engine is provided and adapted to render VXML pages, which are results of functioning application logic. These pages, which are used as input for voice synthesis, are rendered according to a specific generation sequence or call flow.

A VXML-enabled voice portal, which may be a telephony server, is adapted to enable retrieval of VXML pages from the VXML rendering engine. A VXML interpreter, a voice recognition text-to-speech engine, and the telephony hardware/software are combined to provide voice interface function. In prior art, the telephony hardware/software along with the VXML interpreter are packaged as an off-the-shelf IVR-enabling technology. Arguably the most important feature, however, of a VXML system is the voice application server. Voice application logic is typically written in a programming language such as Java and packaged as an enterprise Java Bean archive. The application presentation logic required is handled by the VXML rendering engine and is typically written in JSP or PERL.

As development progresses in the field of voice recognition software, hardware, and text-to-speech synthesis, it has become possible to streamline the voice interaction process including erasing former telephony boundaries to create new customer access and interaction environments. Still further, voice application services are being developed for use by multiple enterprises as enterprise tenants of a central system, wherein each enterprise tenant relies on common voice application architecture, configuring enterprise-specific function over it. Such systems enable enterprise-specific function to be configured over basic application logic such that customers of those enterprises may experience interaction with enterprise services as if they were interacting with a proprietary enterprise voice application system.

The inventor knows of a U.S. patent application Ser. No. 10/803,851 referenced in the cross-reference section of this specification. The system disclosed includes a voice application server for creating and serving voice applications to clients over a communication network; at least one voice portal node having access to the communication network, the portal node for facilitating client interaction with the voice applications; and an inference engine executable from the application server. In a preferred embodiment the inference engine is called during one or more predetermined points of an ongoing voice interaction to decide whether an inference of client need can be made based on analysis of existing data related to the interaction during a pre-determined point in an active call flow of the served voice application, and if an inference is warranted, determines which inference dialog will be executed and inserted into the call flow.

A behavioral adaptation engine is also known to the inventor and may be integrated with the voice application creation and deployment system Ser. No. 10/803,851 described above. The adaptation engine has at least one data input port for receiving XML-based client interaction data including audio files attached to the data; at least one data port for sending data to and receiving data from external data systems and modules; a logic processing component including an XML reader, voice player, and analyzer for processing received data; and a decision logic component for processing result data against one or more constraints. The engine intercepts client data including dialog from client interaction with a served voice application in real time and processes the received data for behavioral patterns and if attached, voice characteristics of the audio files whereupon the engine according to the results and one or more valid constraints identifies one or a set of possible enterprise responses for return to the client during interaction.

The enhanced system described in the above paragraph can dynamically select responses based on detection of a particular mood state and re-arrange a menu or response-options accordingly. The behavioral adaptation engine has the capability of determining what appropriate response dialog from a pool of possible dialogs will be executed during a session based on voice and selection analysis performed by the client during the session.

It is known in current art of general network-based advertisement presentment that a customer, using a network-connected appliance running a data search interface, may perform keyword search using one or more keywords or phrases describing the subject matter sought by the customer to obtain results relevant to the input, the results accompanied by keyword-relevant advertisements. If the nature of the search interface is private, links returned may be those to actual company products that may be downloaded (if media-based), or ordered and shipped if hard consumables. On a typical results page returned using a public search interface, advertisers whom have subscribed to ad placement services may have hyperlink-enabled graphic or textual ads served in a special ad space on the page adapted for the purpose and reserved for advertisers competing for the space. Potential consumers may then interact with such presented ads instead of returned results thereby being redirected in network navigation to a web site hosted by the ad-originating enterprise and linked to by the selected ad.

The above advertising venue requires that the advertisements submitted for placement be relevant to keywords and/or phrases that a potential client might enter in a search for a related product or service thereby drawing relevant clients to offered services by keyword and, or phrase match. Therefore the advertisement by nature may be designed and supported by backend services in a fashion that limits fulfillment services related to the ad to a specific product or service for which the keywords were submitted for ad placement and which were matched to the client's search engine, term, terms, or phrase. Likewise, the actual mechanism for fulfillment after a customer selects an advertisement, may be somewhat elusive to the customer because the link may typically redirect the customer to a general products or services page hosted by the advertiser and supporting additional products or services, some of which may not necessarily be content-related to the search terms used to invoke original presentment of the advertisement. The customer may then be required to perform significant additional navigation tasks in order for the conversion from ad selection to product or service purchase to be successfully realized by the advertiser. Moreover, if the ad selected is linked to a call center queue or a static voice assistant, and more than one product or service is represented by the host, the customer may require additional pre-screening in order to match the customer intent with the correct product or service being offered.

The inventor is aware of a system for inserting advertisements into a voice application. This system referenced as U.S. provisional patent application 8119 Ser. No. 60/581,924 in the cross-reference section of this specification. The system is used for selecting an advertisement from a pool of advertisements and for causing the selected advertisements to be used by a voice application system for presentment to a caller during caller interaction with a voice application. The system includes a voice-enabled interaction interface hosting the voice application, and a server that monitors the interface. The server selects the advertisement in real time and serves at least the identification and location of the advertisement to be presented to the caller via the voice application. In practice, the server receives and analyzes data about the caller and compares the data against at least one rule. The resulting of that process provides reference to the advertisement selected for presentment to the caller.

The inventor knows of a multi-tenant voice application service referenced in the cross-reference section of this specification as Attorney docket 8126 Ser. No. 11/072,062. The multi-tenant voice system includes a voice portal connected to at least one telephony network and a voice application server integrated with the voice portal. The system also includes a multi-tenant configuration application integrated with the voice application server. The configuration application is accessible to tenants of the system from a data packet network. The system enables enterprise tenant to configure enterprise-specific voice application function over shared voice application architecture.

The multi-tenant aspect of voice application service technology has enabled new venues for advertising and new ways to target advertisements more specifically by relating ads to voice application content and presenting those advertisements as interactive voice dialogs. The inventor knows of a system referenced in the cross-reference section of this specification as attorney docket 8127 Ser. No. 11/087,030. The just-mentioned system is an advertisement delivery system for publishing a voice-enabled advertisement chosen among multiple voice-enabled advertisements to a specific voice application version chosen among multiple voice application versions available to the system. The system includes a telephony interface for enabling voice interactive access to at least one running version of the chosen voice application, a matching service application for determining selection of the advertisement, the voice application version to host the advertisement, and at least one advertisement position in the voice application version for presenting the advertisement. Such advertisements selected and served by the above system may be targeted to specific customers based on real time customer behavior, customer profile, customer interaction history, and even emotional attributes exhibited by customers detected in real time during voice interaction with a voice application.

Still more innovation is required, however, to expand voice application services and targeted advertising presentment through voice services to include new network-based system-access windows that are not now available to customers. Still further, it is desired that advertising may be targeted to those potential new customers wherein some accurate indication of content relevancy for advertisement determination and for interactive dialog determination may be exhibited to and recognized by a voice application server before or immediately at the time of voice connection between the system and accessing customers.

Therefore, what is clearly needed is a system that may provide for an advertising link to a voice application whereby selection of the specific advertisement presented or, in some cases returned as a search result connects the customer to a voice application and further directs the selection and presentment of specific interaction dialog options and additional advertising dialog options available to the application according to relevancy of the keywords and, or phrases used in the data search.

### SUMMARY OF THE INVENTION

A system for dynamic advertisement selection and presentment within a speech application is provided. The system includes, a user operable network browsing interface in communication with a server on a data network; at least one voice link to a voice application interface, the link or links accessible to the user working within the browsing interface; a pool of at least one advertisement for presentment; and a selection engine accessible to the voice application interface for receiving criteria originated from the server for advertisement ranking and for selecting an advertisement from the pool of at least one advertisement for placement based on the received criteria.

In a preferred embodiment, the user interface is a network browser containing a search engine interface and the data network is the Internet network. In this embodiment, the communication includes user interaction with a search result page served to the user interface from the server as a result of search engine interaction. Also in a preferred embodiment, the voice link is an embedded instruction for establishing a voice connection between a user telephony application or device and the voice application interface.

In one embodiment, the voice application interface is a telephony server enhanced for voice over Internet Protocol. Also in one embodiment, the voice link is embedded in one or more sponsored advertisements appearing on the search result page, the advertisements relevant to the user's search engine input criteria. In another embodiment, the voice link is embedded in one or more search results listed in the search result page, the search results relevant to the user's search engine input.

In a preferred embodiment, the criteria for advertisement selection comprise one or more keywords or a phrase entered into a search engine. In preferred embodiments, the advertisement for presentment is a pre-recorded or voice synthesized advertisement that fits into an advertisement slot in the speech application. In one embodiment, the criteria for advertisement selection further comprise interaction data recorded at the voice interface during interaction with the speech application.

According to one aspect, the system further includes an application program server interface for collecting the relevant criteria and for passing that data along with or ahead of the voice session established via interaction with the voice link.

In still another aspect, the system further includes a pool of selectable speech dialogs wherein the criteria received is used to rank and select a voice dialog from the pool for presentment to the user. In this aspect, the criteria comprise one or more keywords or a phrase.

In one embodiment, the pool of at least one advertisement includes third-party advertisements competing for placement. In another embodiment, the pool of at least one advertisement includes enterprise-sourced advertisements competing for placement.

According to yet another aspect of the present invention, a software program is provided for collecting information relevant to a user operating a search engine interface during a data session, causing a voice link to be established between a telecommunications capable device of the user and a remote voice interface, and for forwarding the information collected to the remote interface. The program includes a server/client connection monitor; a backend server connector; and a telecommunications/proxy layer. The voice link connects the user to a voice application system and the data forwarded to the voice interface serves as ranking and selection data for determining and presenting one or more dialog options through the speech application to the user over the voice link.

In one embodiment, the program is installed and runs on a server hosting data search services on the Internet network. In another embodiment, the program is installed and runs on a computing device operated by the user. In a preferred embodiment the information collected includes keyword and or phrase input typed into the search engine interface.

In one embodiment, the voice link is a voice over Internet protocol connection initiated as a result of the user interacting with a served advertisement resulting from search engine input and submission activity. In a variation of this embodiment, the telecommunications device is the computing device enabling access to the search services. In another variation of the embodiment, the telecommunications device is a cellular telephone.

In a preferred embodiment, the server/client monitor collects the IP parameters of the client session and collects keyword and phrases used in each search submission. In one embodiment, interaction with the voice link establishes a telephone connection between a telephone operated by the user and the voice interface. In this embodiment, the telephone is one of an application on a computer operated by the user, an Internet protocol telephone, or a smart wireless telephone.

In one embodiment, the backend server connector enables access to client data stored in a database including contact information, purchase history, and statistical data. Also in one embodiment, the telecommunications/proxy layer establishes a voice over Internet protocol connection by connecting to the voice interface and then connecting the user to the session. In another embodiment, the telecommunications/proxy layer establishes a server-to-server connection with instructions to place an outbound call from the voice interface to a user's telecommunications device or application.

According to still another aspect of the present invention, a method is provided for using search engine input collected during a data session between a network-capable computing device operated by a user and a network server as ranking and selection criteria for determining an advertisement for presentment to the user through a speech application. The method includes steps for (a) collecting search engine input data during an active Internet protocol data session; (b) detecting user interaction with an embedded voice link served in a search engine result page; (c) establishing a voice session between the user and a remote speech application interface; (d) forwarding the input data to the speech application interface before or at the time the voice link is established; and (e) utilizing the forwarded data to select an advertisement dialog for presentment to the user through the speech application.

In a preferred aspect, in step (a), the input data are the exact keywords or phrase typed into the search interface. In one aspect, in step (b), the voice link is embedded in an advertisement served as a result of submission and receipt of the input data. Also in one aspect, in step (c), the voice session is one of a voice over Internet protocol session, or one of a telephone call.

In another aspect of the method, in step (d), the input data is augmented with data about the user. In all aspects, in step (e), the selected advertisement is a pre-recorded or voice synthesized advertisement dialog that fits into an advertisement vacancy in a speech application.

### BRIEF DESCRIPTION OF THE DRAWING FIGURES

FIG. 1 is an architectural overview of a communications network including a multiple-tenant VXML service provider according to an embodiment of the present invention.

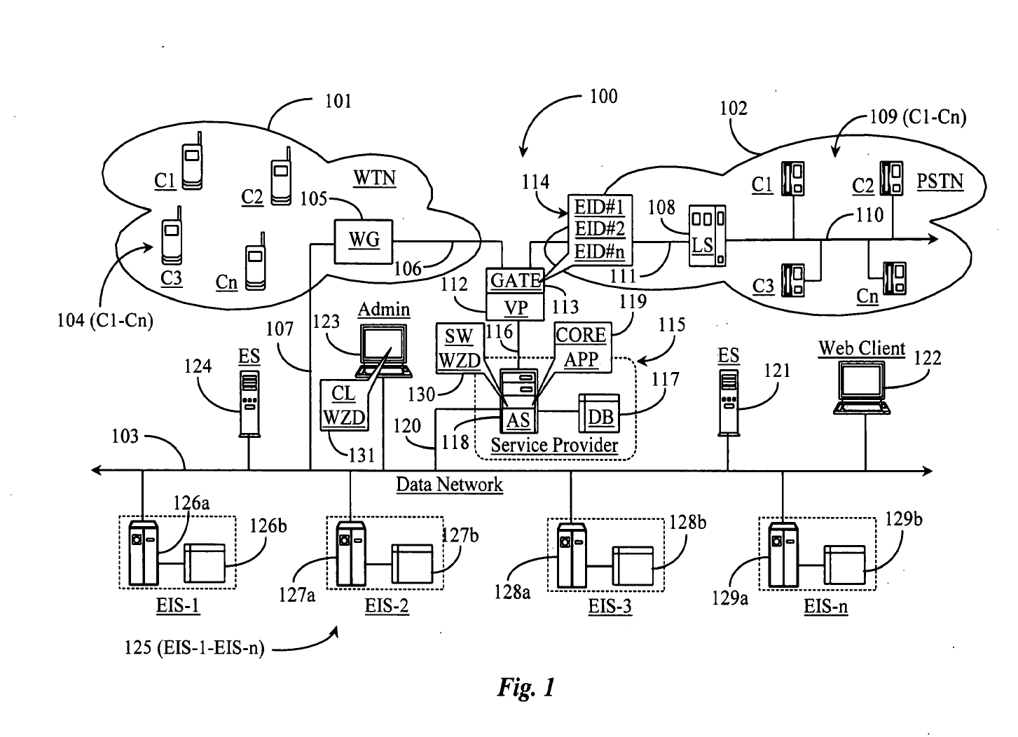

FIG. 2 is a block diagram illustrating basic components of a VXML application and multi-tenant wizard according to an embodiment of the present invention.

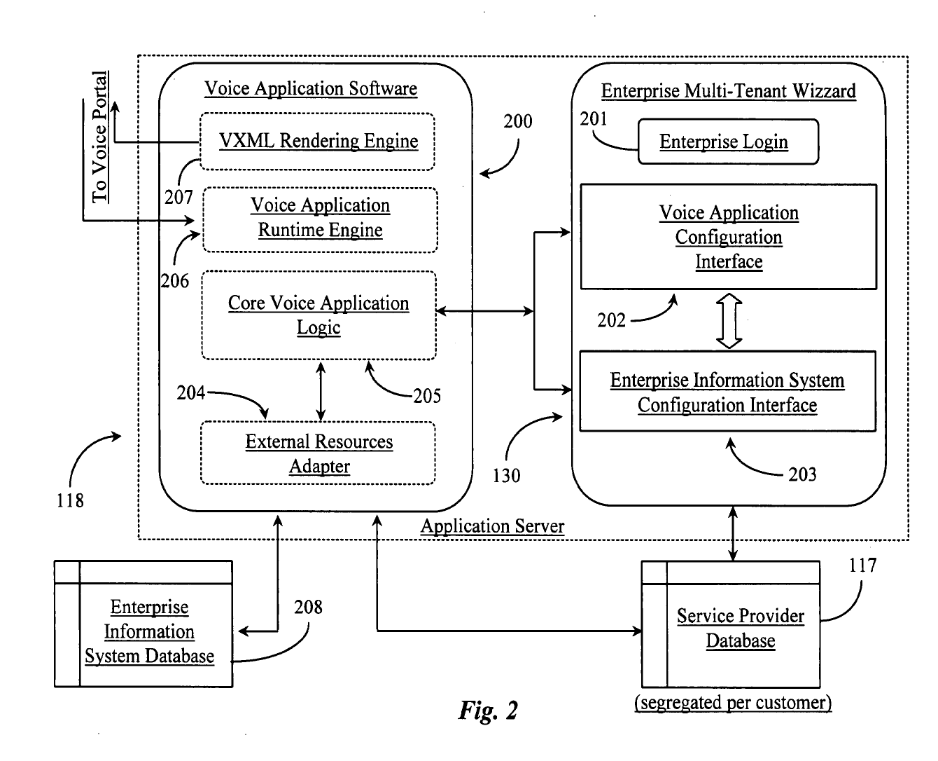

FIG. 3 is a block diagram illustrating components of an enterprise-specific application shell according to an embodiment of the present invention.

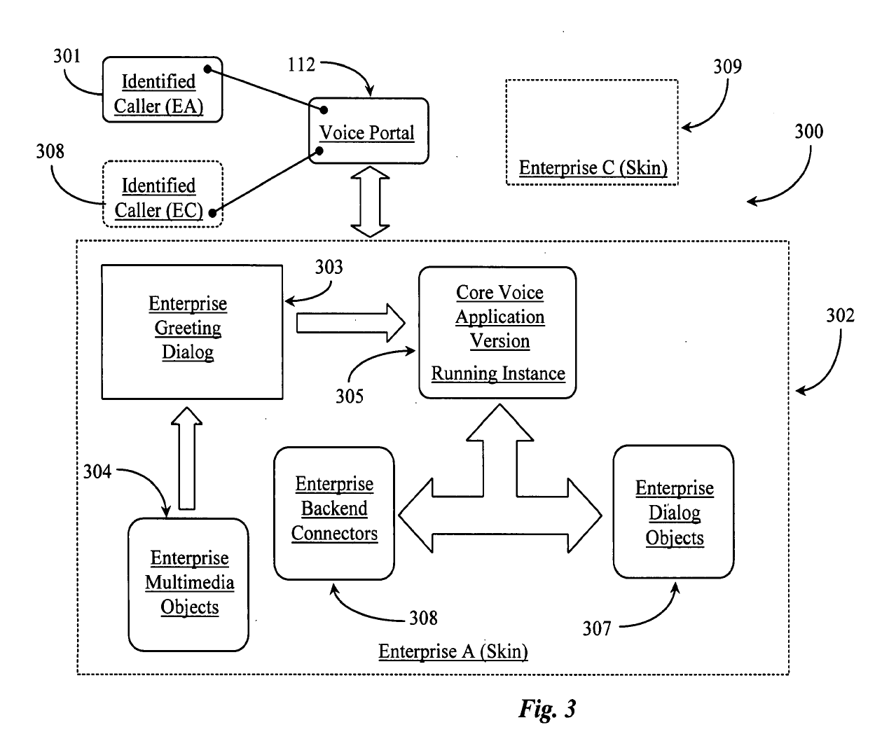

FIG. 4 is a block diagram illustrating components of an enterprise-specific application shell according to another embodiment of the present invention.

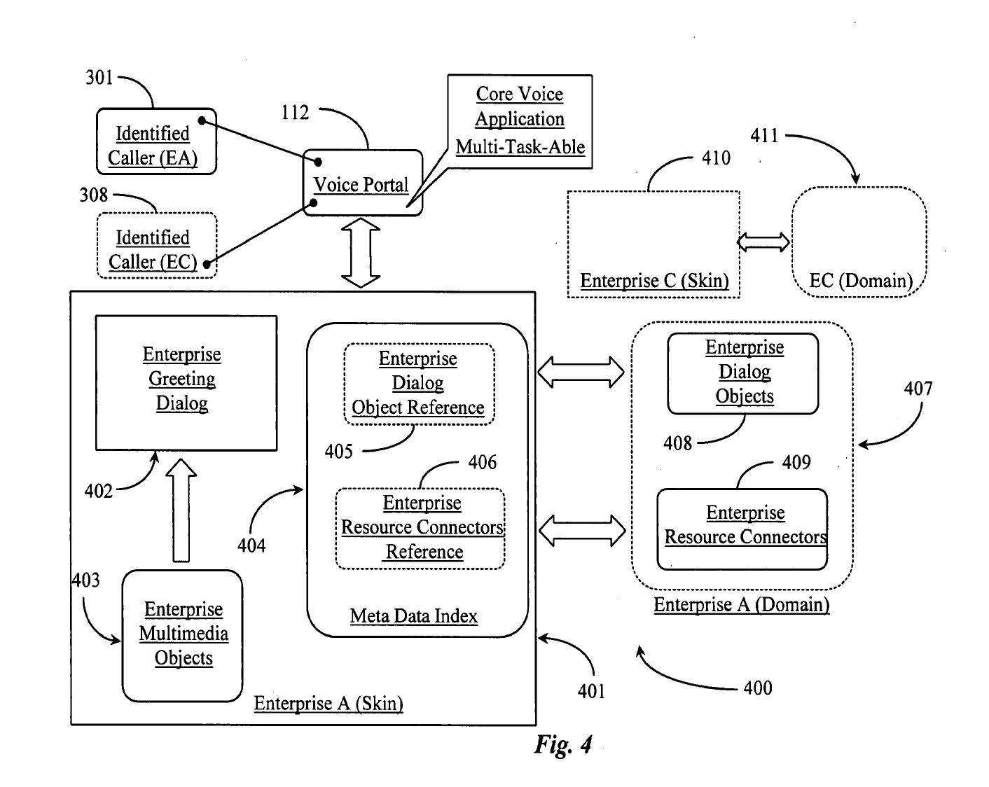

FIG. 5 is a process flow chart illustrating steps for accessing and interacting with an enterprise specific version of a core voice application according to an embodiment of the present invention.

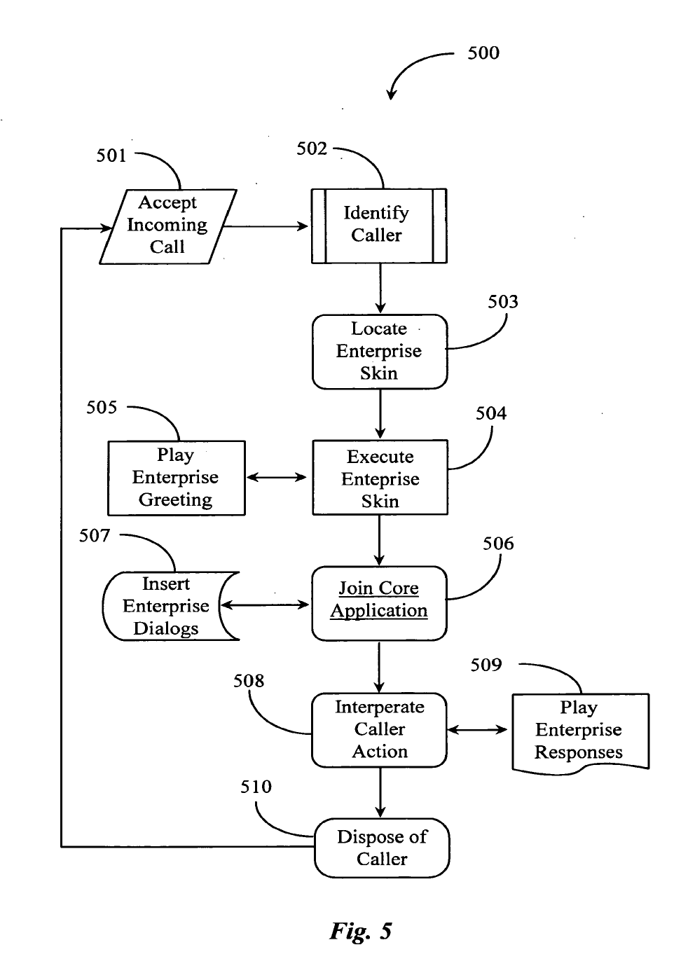

FIG. 6 is a process flow chart illustrating steps for administering modifications to an enterprise-specific application shell according to an embodiment of the present invention.

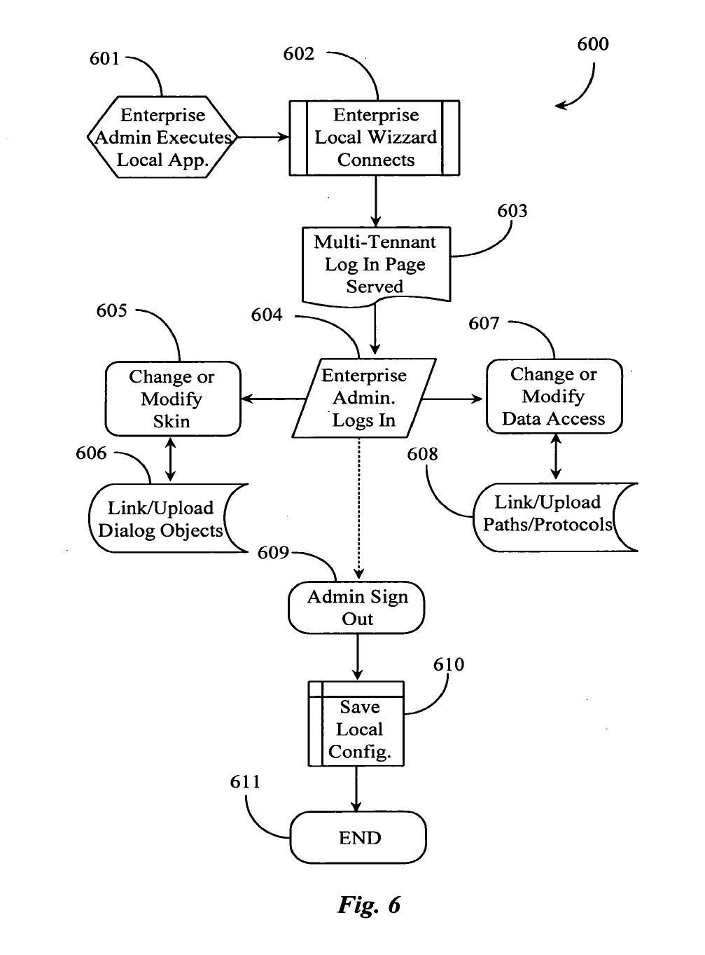

FIG. 7 is an architectural view of a multi-tenant advertisement delivery network and system host according to an embodiment of the present invention.

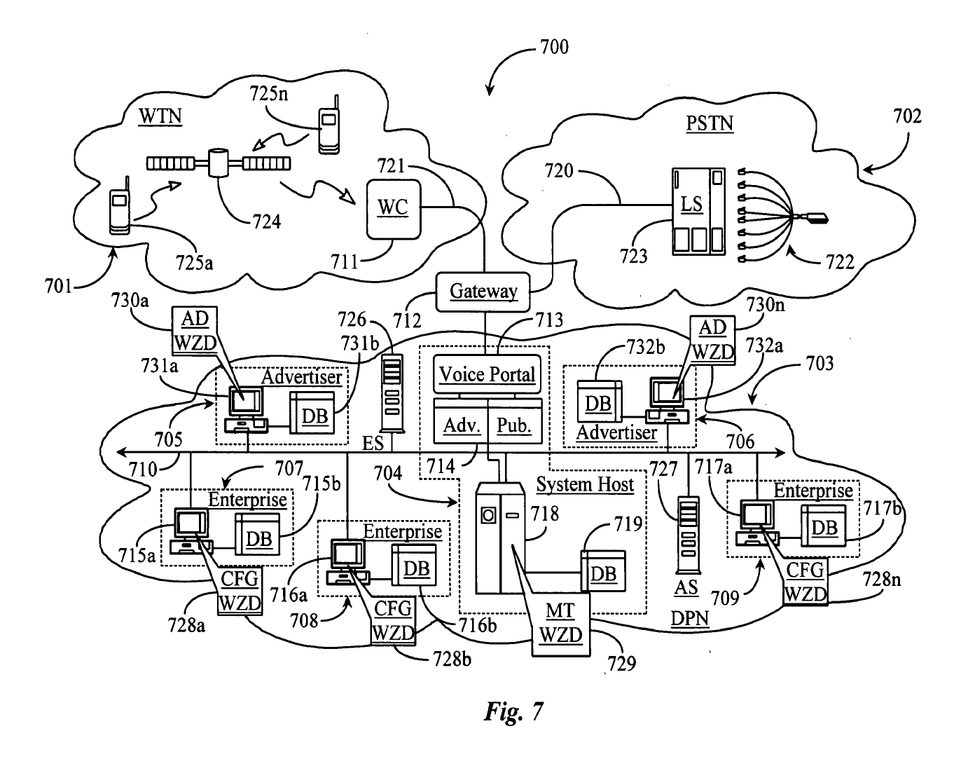

FIG. 8 is a block diagram illustrating components of a voice application server enhanced for selecting and inserting ads into a voice application according to an embodiment of the present invention.

FIG. 9 is a block diagram illustrating a voice interaction manger and voice portal integrated for real time ad selection and service according to an embodiment of the present invention.

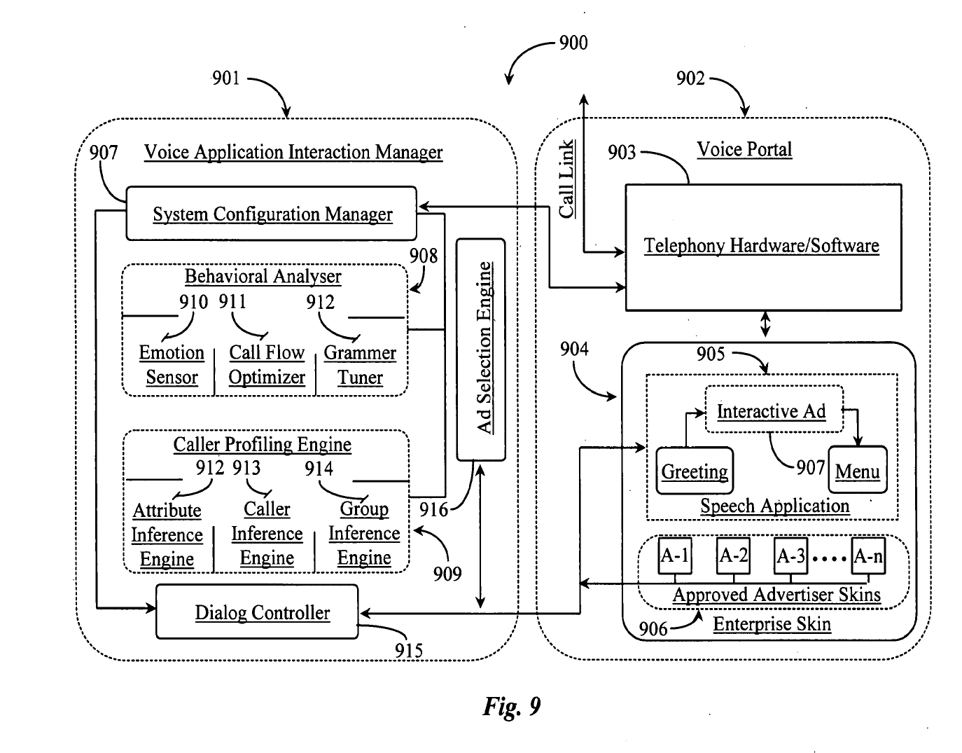

FIG. 10 is a block diagram illustrating integrated layers of interacting components of an ad configuration and delivery network according to an embodiment of the present invention.

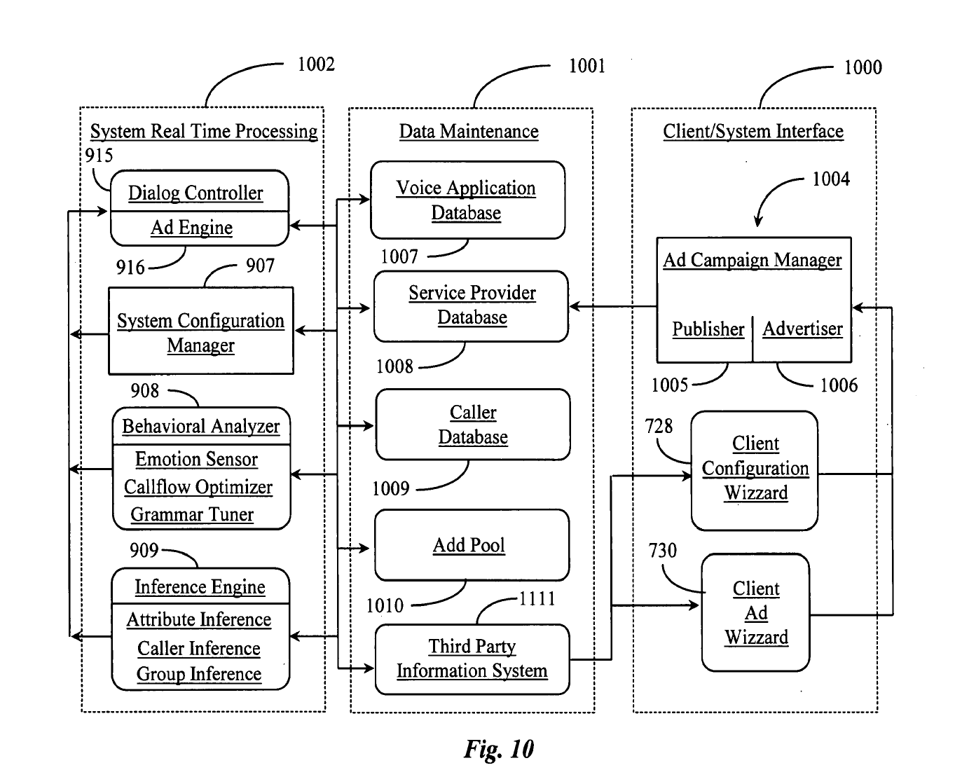

FIG. 11 is a block diagram illustrating functions of a multi-tenant ad campaign manager according to an embodiment of the present invention.

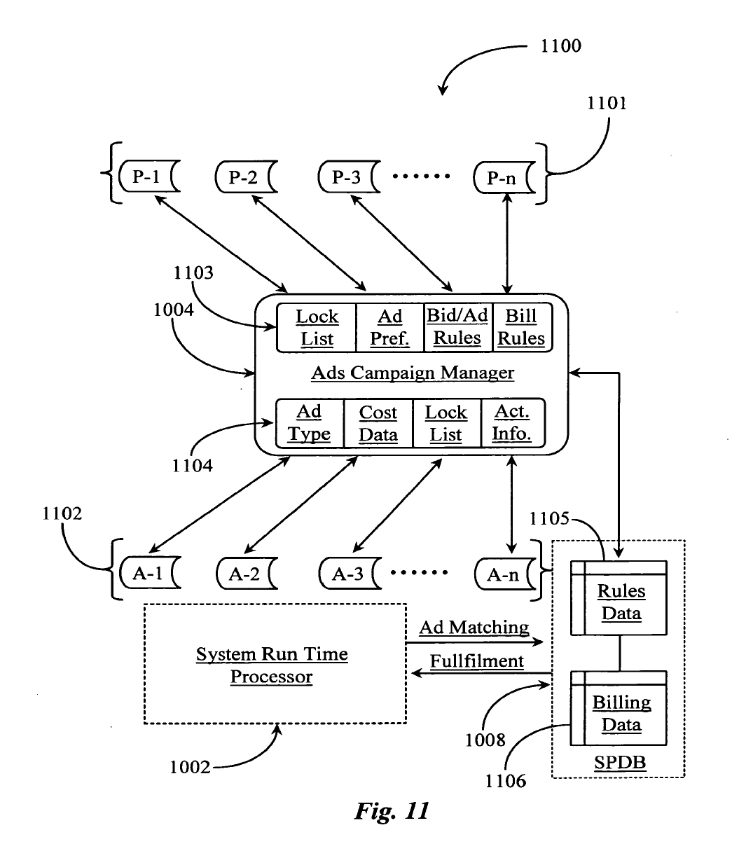

FIG. 12 is a process flow chart illustrating steps for registering an ad for placement according to an embodiment of the present invention.

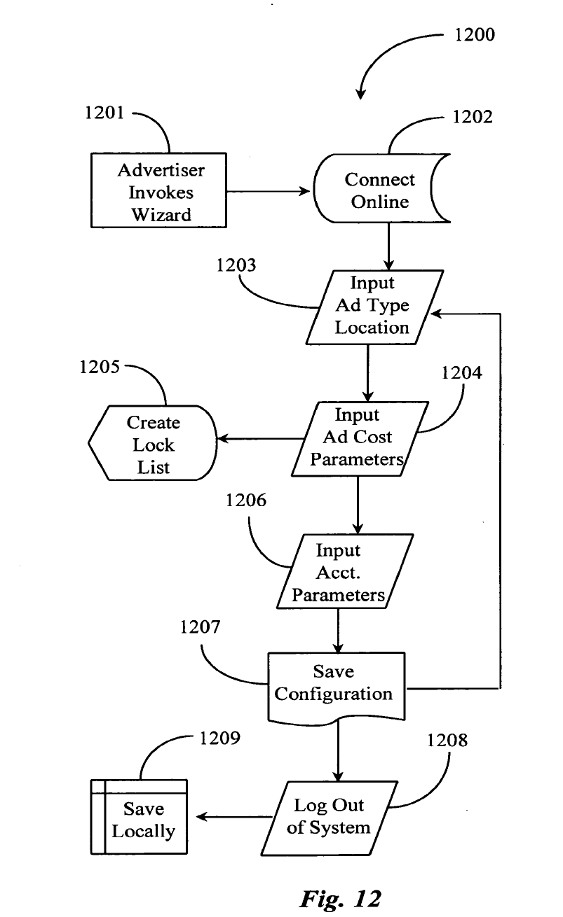

FIG. 13 is a process flow chart illustrating steps for identifying advertisers and ads accepted for placement according to an embodiment of the present invention.

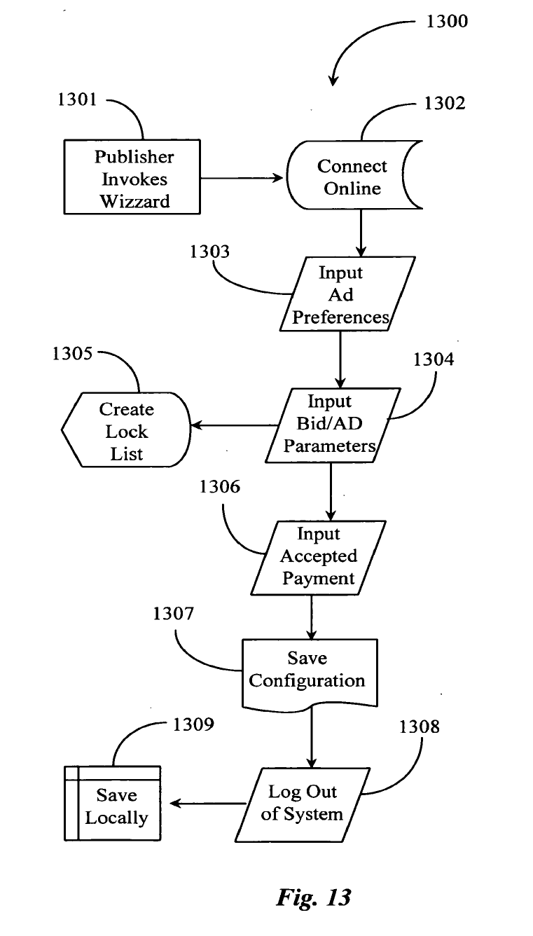

FIG. 14 is a process flow chart illustrating steps for detecting ad vacancies, selecting an ad and inserting the ad into a running voice application according to an embodiment of the present invention.

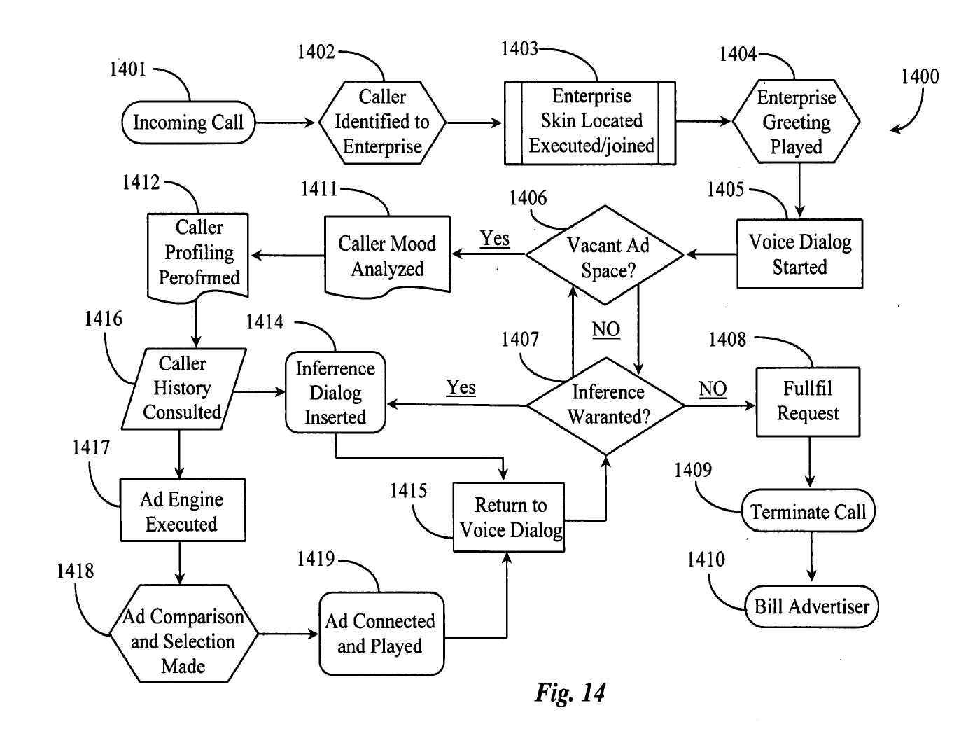

FIG. 15 is an architectural overview of a communication network wherein voice application linking and advertisement selection and delivery is practiced according to an embodiment of the present invention.

FIG. 16 is a block diagram illustrating interacting components of a voice portal and voice application server responsible for ad selection and insertion into a voice application according to an embodiment of the present invention.

FIG. 17 is a block diagram illustrating components of an application program server interface for linking a potential customer to a voice application according to an embodiment of the present invention.

FIG. 18 is a process flow chart illustrating steps for linking a potential customer to a voice application and serving one or more dynamic dialogs the customer through the application according to an embodiment of the present invention.

FIG. 19 is a block diagram illustrating a voice application system for linking a potential customer to a voice application system according to another embodiment of the present invention.

FIG. 20 is a process flow chart illustrating steps for fulfilling a customer music order using the system of FIG. 19.

### DETAILED DESCRIPTION

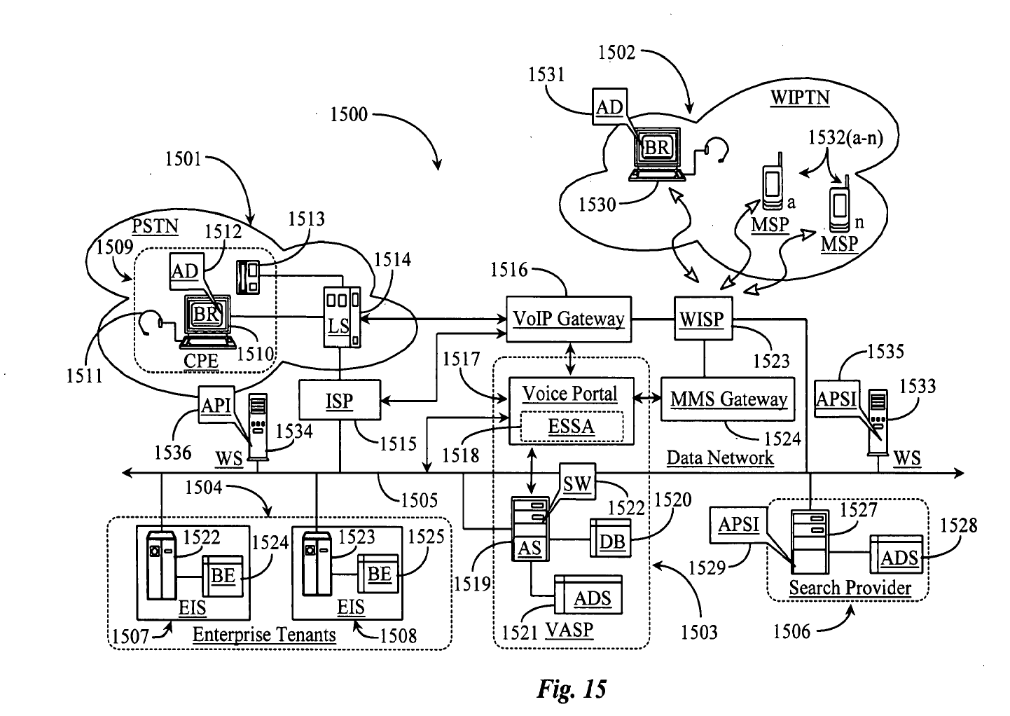

FIG. 15 is an architectural overview of a communication network 1500 wherein voice application linking, dynamic dialog selection and delivery is practiced according to an embodiment of the present invention. Communication network 1500 includes, in this example, a public-switched-telephony-network (PSTN) 1501, a wireless-access Internet protocol telephony network (WIPTN) 1502, and a data network represented herein by a data network backbone 1505 and connected equipment.

Data network backbone 1505 may represent an Internet network, an Intranet network, or some other wide area network (WAN), corporate or privately owned. In a preferred embodiment, backbone 1505 represents the Internet network and may hereinafter be referred to as Internet 1505. Backbone 1505 includes, by logical representation, all of the lines, access points, and equipment that make up the Internet network as a whole. Therefore, there should be no geographic limitations placed on the practice of the present invention.

A voice application service provider (VASP) is illustrated in this example and has components therein which are shown connected to Internet 1505 for data communication to other connected nodes. VASP 1503, in this example, is adapted to provide voice application services for multiple enterprise-tenants illustrated herein as enterprise tenants 1504, also shown connected to Internet 1505 for data communication with other nodes. VASP 1503 includes a voice portal 1517 running an enterprise-specific speech application 1518. The speech application is served by an application server (AS) 1519. AS 1519 is adapted to server and service voice applications. AS 1519 has a voice application software suite (SW) 1522 installed thereon and executable thereon. VASP 1503 also includes a service provider database (DB) 1520 and an advertisement database (ADS) 1521.

Voice portal 1517 may be a VXML-enabled portal and has connection to Internet 1505 via a data connection 1518. Portal 1517 may also be adapted to recognize and work with other voice markup languages such as speech application language text (SALT). Portal 1517 has a connection to a voice over Internet Protocol (VoIP) gateway 1516, and to a multimedia messaging service (MMS) gateway 1524. The described gateways provide general communication access to VASP 1503, more specifically, to portal 1517 from networks 1501 and 1502. SW 1522 includes at least core voice application logic, voice application development tools, voice application configuration software, and runtime application service components used to match customers accessing portal 1517 to enterprise tenant functionality and to match advertisement dialogs and, in some cases voice application dialogs to accessing customers based on data known about those customers including data input by those customers, which may be passed along to the system from remote electronic interfaces according to a preferred embodiment of the present invention.

Enterprise tenants 1504 are represented in this example separate enterprise information systems (EIS) 1507 and EIS 1508. EIS 1507 includes a data server 1522 and a back end (BE) database 1524. EIS 1508 includes a data server 1523 and a back-end database 1525. There may be many more than 2 enterprise information systems such as EIS 1507 and 1508 illustrated in this example without departing from the spirit and scope of the present invention. As tenants of VASP 1503, EIS 1507 and EIS 1508 may be assumed to have enterprise-specific speech applications like ESSA 1518 configured for presentation to customers through voice portal 1517. Likewise, each enterprise may also be adapted for ad publishing through their enterprise-specific voice applications, or for creating and submitting ads for publishing by other enterprise tenants of the system as is described with reference to attorney docket P8127 Ser. No. 11/087,030.

A data search provider 1506 is illustrated in this example and represents any of many well-known Internet data search service provider adapted for returning search results to search-engine interfaces based on input submitted thereto by users operating such interfaces for the purpose. Examples of relevant data-search service providers include Yahoo™, Google™, Alta Vista™, Excite™, among others competing in the field.

Search provider 1506 includes a data server 1527 and, in this example, an advertisement database (ADS) 1528. It will be apparent to one with skill in the art that a data search service provider will maintain many data servers and repositories and will also maintain other equipment and software not illustrated here that may be used to perform common data-search and return functions relying on user input for return of universal resource locators (URLs) to Web sites relevant to user keyword or phase input criteria. Provider 1506 may, instead of providing general data-search services over Internet 1505, be a private data-search service that is part of or linked to a corporate domain, perhaps that of an online music provider, or an online software provider. There are many variant possibilities.

In this present example, provider 1506 is a general data-search service provider that also provides advertisement space for serving dynamic text or graphic advertisements submitted thereto by competing enterprises seeking to advertise to potential customers. In this example, advertisements maintained in database 1528 are key-word and/or phrase-sensitive and are selected and served into available advertisement space reserved for the purpose on data search result pages compiled and returned to users whom have submitted search terms, keywords, phrases and the like in general or more specific data searches. The venue is a recent advent in advertising and advertisement customers submitting advertisements for placement are charged according to click rate received on placed advertisements.

A Web server (WS) 1533 and a Web server (WS) 1534 are illustrated in this example and are shown connected for communication to Internet backbone 1505. Servers 1533 and 1534 represent customer-accessible servers maintained for the purpose of providing consumer-based services to customers including, in one embodiment, data search services. For example, server 1533 may include an online service site for a company that offers music purchased over Internet 1505. Server 1534 may be another example of a server including a company site offering products such as computer software for purchase. These servers may be adapted to maintain and serve information pages or files and media for purchase and download, and may be assumed to include company site and product search services adapted to help customers find the products they are seeking through one or more search interfaces that accept product keywords and the like as criteria for returning search results to users, typically in the form of one or more search-result pages containing links to products. In one embodiment, servers 1533 and 1534 may be customer access servers supported by EIS 1507 and EIS 1508. Likewise, servers 1533 and 1534 may be shared by several enterprises and may be hosted by one or more third-party enterprises that provide domain and Web-site hosting services and electronic shop (e-shop) services to enterprises.

Voice portal 1517 within VASP 1503 is accessible through VoIP gateway 1516 from PSTN 1501 or from WIPTN 1502 as previously described. A customer premise equipment (CPE) domain 1509 is illustrated within PSTN 1501 in this example and represents an entity or user that may connect to Internet 1505 using a personal computer (PC) 1510 and an Internet browser (BR). In this example, computer 1510 has a connection to a local telephony switch (LS) 1514 using a dial-up modem for network access through an Internet service provider (ISP) 1515 adapted in this example to provide network connection services.

Other Internet access methods may replace dial-up access in this example without departing from the spirit and scope of the present invention such as cable modem, digital subscriber line (DSL), broadband connection, including WiFi link including wireless municipal area network (MAN). There are many network access possibilities. CPE 1509 may also include a telephone 1513 for making and receiving telephone calls. Likewise, computer 1510, which may be a desktop version, a laptop version or a pocket PC may be assumed to be adapted for IP telephony as illustrated herein by an IP-telephony headset 1511 connected to computer 1510. Using computer 1510 with a browser running, a user may connect online to Internet 1505 through, in this case, LS 1514 and ISP 1515, and may then navigate, once connected to servers 1533 and 1534 and to server 1527 to access services.

Within WIPTN 1502, there is illustrated a PC 1530 adapted for wireless Internet access through a wireless Internet service provider (WISP) 1523 adapted to provide Internet access to consumers operating wireless access devices. WISP 1523 has a cabled Internet-access connection to Internet 1505 and communicates wirelessly to PC 1530. PC 1530 once connected to Internet 1505 and running a Web browser (BR) has access to services described as provided from WS 1533 and from WS 1534 and from search provider server 1527. Also illustrated within WIPTN 1502 is a plurality of media-capable-smart telephones (MSPs) 1532 (a-n). MSPs 1532 (a-n) may be 3G (third generation) wireless telephones capable of simultaneous high-speed Internet connection and wireless telephony using a wireless carrier. MSPs 1532 (a-n) may be operated by users to navigate Internet network 1505 including browser-based access of Web servers 1533, 1534, and search provider sever 1527 in an efficient manner similar to what may be expected from a powerful desktop PC. As such, MSPs 1532 (a-n) may include software media players for playing video and audio and for displaying graphics, as well as, being enhanced for media storage (up to 3 gigabytes) for instant playback after download and for multi-media messaging.

MSPs 1532(a-n) communicate wirelessly to WISP 1523 to establish Internet connectivity to Internet 1505. While remaining connected to Internet 1505 through WISP 1523, MSPs 1532 (a-n) may also establish separate telephone calls through VoIP gateway 1516 into the PSTN network 1501. VoIP gateway 1516 may also be a standard PSTN gateway for bridging data packet networks (DPNs) to connection-oriented-switched-telephony networks (COST).

In practice of the present invention, an application program server interface (APSI) is provided to Web servers that include data search services made accessible to users and that may also provide third-party advertisement placement services to advertisers. An instance of APSI 1535 is illustrated as installed on server 1533. An instance of APSI 1536 is illustrated as installed on server 1534. An instance of APSI 1529 is illustrated as installed on server 1527 within the domain of search provider 1506.

In the embodiment of a data-search service provider, the provider may allow advertisers to configure advertisements for third-party placement to data search result pages returned to users by associating the advertisements to be submitted for placement to search-term relevant keywords or phrases that the advertiser envisions might be used as input in a search engine to cause return of links to content that may be considered relevant to the search. This process is known in the art as described in the background section of this specification. Typically, if a user clicks on a placed advertisement, he or she will be directed to a Web site hosting the advertisement, or to a live agent queue or automated attendant by a hyperlink that includes a telephone number.

In a preferred embodiment of the present invention, the process described in the above paragraph is further enhanced according to one embodiment of the present invention such that a user, like one operating computer 1510 may click on a placed advertisement link and be directed according to “user preference” to voice portal 1517 through ISP connection service 1515 and through VoIP gateway 1516, which has connection to ISP 1515, or to portal 1517 through LS 1514 and through VoIP gateway 1516. APSI 1529 gathers data about the user including, but not limited to physical connection data like originating IP address and destination IP address, telephone contact information, any user-stated preferences related to the service, and the user search criteria used to cause the advertisement to be placed on the search result page from which it is selected by the user. In the case of user “preference data” collected by APSI 1529 such as disclosed telephony contact information, it may be assumed that the user has previously configured release of the information to the service provider in order to enable some enhanced features such as automatic callback over a separate line such as to telephone 1513, for example.

APSI 1529 may pass the data collected of the user along with the connection established by invoking the advertisement to voice portal 1517. Using the information received, portal 1517 may match the user to the appropriate enterprise-specific speech application 1518 delivered to portal 1517 by AS 1519 in this case. ESSA 1518 may have vacant advertisement slots available therein that may be filled by advertisements directed particularly to the user. SW 1522 may receive the relevant keyword or phrase data passed with the connection established and may use that data as a whole or partial criteria for selecting one or more voice-enabled advertisements from database 1520 for dynamic insertion into ESSA 1518 whereupon that advertisement or advertisements are voice synthesized, or otherwise played as part of ESSA. Likewise, ESSA 1518 may include options for dialog optimization wherein an optional dialog may be played instead of a default dialog. In this case, analysis of the keyword and/or phrasing used in the original search may be a whole or partial factor is selection of which of optional dialogs to present.

Consider the following exemplary use-case scenario: a user operating computer 1510 accesses search provider server 1527 and performs a data search entering the specific keywords pet and products. A relevant advertisement stored in database 1528, the advertisement submitted, for example, by one of enterprise tenants 1504 configured to at least one or more of those search keywords is then served in the ad space provided in the search result page along with some other relevant advertisements. APSI notes that the particular advertisement was served. If the user then mouse clicks that advertisement or otherwise invokes the advertisement, illustrated in this example as AD 1512 displayed on computer 1510, APSI 1529 may collect user data including the keywords used to invoke the advertisement and may pass the data along with the call to voice portal 1517. The established connection may be a Web link (additional Web session using the same main connection) or a telephony connection over a separate telephone line. In the latter case, the telephone connection may be established as an automated outbound telephone call or a telephone call bridged to PC 1510 that may be answered from the PC by the user operating headset 1511.

The user is now connected to voice portal 1517 for communication. SW 1522 may automatically determine by virtue of the connection nature such as telephone number called or IP address linked to in the served and selected advertisement, which ESSA 1518 to serve for presentment to the user through voice portal 1517. In this embodiment, VASP 1503 serves multiple tenants however serving multiple tenants is not required in order to practice the present invention. VASP 1503 may, in one embodiment, represent just a single enterprise without departing from the spirit and scope of the present invention.

AS 1519, using APSI data, more particularly, the keywords “pets” and “products”, determines which advertisement, in this case, located in ADS database 1521 will be presented to the caller through ESSA 1518. In a preferred embodiment, the advertisements in database 1521 are competing for placement and are each associated to keywords and or phrases that might be used in a search engine to return results about a product or service relevant to or subject of the associated advertisement. Therefore, in this case example the advertisements submitted to search provider 1506 for placement are enterprise advertisements and the advertisements selected from database 1521 for dynamic placement into a voice application are those of competing entities seeking ad placement through a particular enterprise, which in this case is also an advertisement publisher.

In one important embodiment of the present invention, the leverage of search engine input may also be used to optimize voice application dialog to present a more content relevant voice application interactive to a caller based on the subject matter the caller is looking for. In this embodiment, APSI 1529 functions just as in the earlier embodiment passing relevant data along with a call or established connection to voice portal 1517. Rather than selecting and serving advertisements that are relevant to the caller's search criteria, AS 1519 with the aid of SW 1522 selects and serves content relevant voice application dialog options (not illustrated) from a pool of available options. Optional dialogs are pre-fitted to a voice application and may be selected and inserted therein automatically and in dynamic fashion. It is noted herein that AS 1519 and SW 1522 may be adapted to select and serve both dynamic advertisements and optional voice application dialogs without departing from the spirit and scope of the present invention.

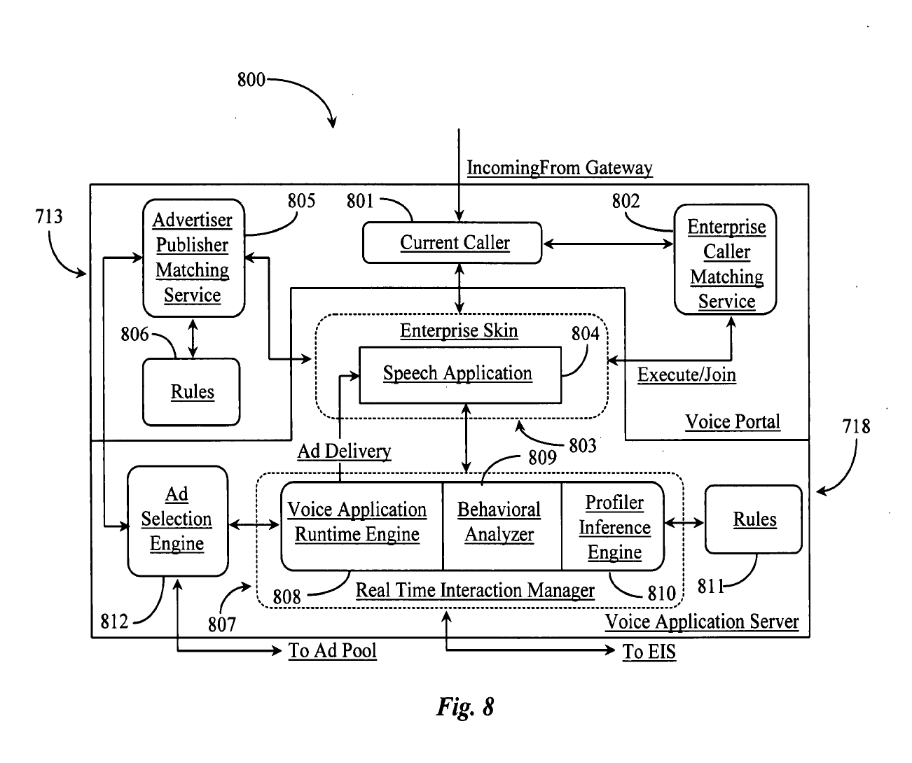

An ESSA like ESSA 1518 may be a part of an enterprise skin as discussed further above with reference to FIG. 8. It is also noted herein that approved advertisements may be part of an advertiser skin that connects as an object when executed to an enterprise skin as discussed with reference to the document referenced in the cross-reference section of this specification as attorney docket 8127 Ser. No. 11/087,030. ESSA 1518 may contain one or more than one advertisement vacancy and one or more than one dialog option optimization point. Actual advertisements and dialog options may be in the form of XML objects, SALT strings, VXML strings, J-Speech objects or actual media files that are pre-recorded and do not require voice synthesis. ESSA 1518 may be adapted to present any of the aforementioned formats.

PC 1530 in WIPTN 1502 may be operated similarly to PC 1510 described in the previous case example. A user may click on AD 1531 returned in a search result page generated within server 1527. Invoking AD 1531 may establish a voice call to portal 1517 through gateway 1516. Likewise MSPs 1532 (a-n) may enjoy all of the connective and navigation functionality thus described in practice of the present invention.

According to one embodiment of the present invention, a user may access Internet 1505 through previously described conventions from either PC 1510 or PC 1530 and may navigate to either WS 1533 or WS 1534 to browse service offered, perhaps those that the user may have subscription to. In this variation, WS 1533 may host music sales and a music download Web site that offers use of a product search engine adapted to enable users to quickly search the site for music samples that are offered for sale and download full versions of any purchased selections. In this case, the keyword input might be the name of an artist, title of a song, or title of an album. The search result page in this case returns music sample links related to the user's search input. By selecting a returned result link, the user may be automatically connected to voice portal 1517 through gateway 1516 whereupon the voice application (ESSA) 115 for enabling voice interactive purchase of music selections offered by the music service is executed and plays for the caller.

In this example, a single company that provides the music download service may own VASP 1503 and therefore be the only tenant. It is also possible that the music service is just one of multiple tenants of VASP 1503. APSI 1535 within server 1533 passes the keyword data and other relevant information to voice portal 1517 along with the call. AS 1519 with the aid of SW 1522 in this case receives the keyword input used to return the original music sample links and the content description of the actual sample that is subject of the user selection. It uses this information to negotiate a purchase of music with the caller that is more content relevant to what the caller is actually interested in. Dialog options and relevant (pre-recorded) music samples may be provided to ESSA 1518 by AS 1519 for dynamic presentment of those samples to the caller through voice portal 1517 and VoIP gateway 1516. If a caller decides not to purchase the selected sample, another relevant sample may be then presented to the caller as an option.

If the user elects to buy a selection, then ESSA may default to a transactional dialog to conclude a sale with the caller. At any time before, or after the caller has purchased a selection, AS 1519 may select and serve an advertisement into an advertisement vacancy in ESSA 1518 if one exists. Such an advertisement may be content relative to the selected subject matter and to keywords or phrases used to return the original link list of music samples. In this embodiment all of the returned product results (music sample links) cause connection to the same telephone number destination rather than configuring universal resource identification (URI) information for linking the user directly to database locations of the music samples for download. The samples are retrieved by AS 1519 and served for presentment by ESSA 1518.

During the interactions, additional closely relevant music samples may be selected and served to the voice application based on the APSI data received during call connection with the caller. In this embodiment, music purchased may be downloaded in a traditional browser-based fashion by subsequently serving or enabling the appropriate music download links during the open data session. In one embodiment purchased music may be sent in the form of actual media after a successful purchase to a user-designated device like to one of MSPs 1532 (a-n) through a multi-media messaging service (MMS) gateway illustrated in this example as MMS 1524 shown connected to voice portal 1517 and to WISP 1523. Likewise, a user may access server 1533 and interact therewith over an Internet session initiated by one of MSPs (a-n) using a browser and may receive actual media over a MMS telephone connection to the same device without interrupting the data session with server 1533.

Advertisements from database 1521 may also be served into a voice application conducting a transaction analogous to the music purchase and download embodiment just described above. These advertisements, like those described further above in the search engine embodiment, are in a preferred embodiment, assigned relevant keywords or phrases that the advertiser envisions a user might input into a music search engine to return music sample links. The advertisements themselves may be somewhat generally relative to the music content selected like, for example, a discount coupon for recording time at a local recording studio, or perhaps a sale on blank compact discs (CD-R) at a local music store. The advertisements may also be more granularly relevant to selected content, for example, tickets on sale for a live show performed by the artist of the music title selected for purchase by the user. There are many possibilities.

One with skill in the art of voice application technology will recognize the methods and apparatus of the present invention may be implemented using VASP 1503 as a service provider to multiple tenants whereby active practice of the invention is enabled encompassing the search engine advertisement embodiment and the private Web site search engine embodiment simultaneously without departing from the spirit and scope of the present invention. Likewise, the methods and apparatus of the present invention may be enabled from a voice portal and application system and software maintained by a single entity without departing from the spirit and scope of the present invention.

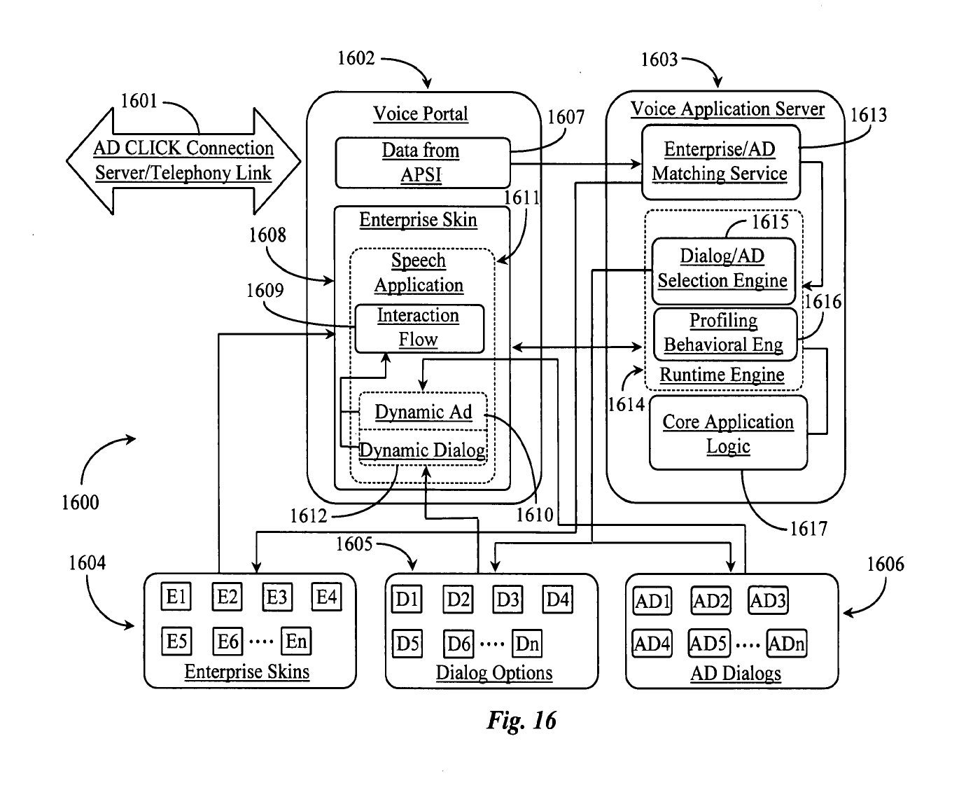

FIG. 16 is a block diagram illustrating a voice interaction system 1600 including a voice portal 1602 and a voice application server 1603 adapted for advertisement and dialog selection and service according to an embodiment of the present invention.

Voice portal 1602 may be analogous to voice portal 1517 described with reference to FIG. 15 above. Voice application server 1603 may be analogous to voice application server 1519 also described with reference to FIG. 15. In this example, portal 1602 and application server 1603 interact together to perform dynamic dialog and advertisement presentment to a caller that has been directed to portal 1602 from a remote electronic interface like a search result page. An incoming event, illustrated logically herein as event 1601 represents either a server link or a telephony link to portal 1602. There are mechanical connection and routing differences between the two links. For example, a telephony connection may be established between the remote computer and telephony hardware and software (not illustrated) maintained in portal 1602. Likewise, the connection established might be an outbound call initiated from portal 1602 after receiving data over a server link. Still further, although not explicitly preferred, a simple server-to-server link may be established over the Internet between portal 1602 and a computer IP telephony application.

Event 1601 is, in one embodiment, initiated when a user browsing a search result page returned clicks on a relevant enterprise advertisement dynamically served into the result page based on relevancy to the user input criteria. In one embodiment, system 1600 is notified over a separate data connection whenever an enterprise advertisement submitted by an enterprise tenant of the system is actually served into a search result page. This may be accomplished by point-to-point communication from the host remote server to the application server or to the voice portal if so adapted. If the customer receiving the advertisement fails to interact with it then no further action transpires.

Event 1601 occurs only when the advertisement is served and is interacted with, typically by mouse click if the network-capable device is a PC. The enterprise advertisement, in this case, may contain the telephone number that the enterprise has registered at the voice portal and all advertisements of that enterprise may be associated with the same telephone number. In this case any user clicking on one of the enterprise advertisements returned is automatically connected to the telephone number using resident computer telephony software on the navigating device to initiate the call.

In one embodiment, a component within the host server that the user is navigating within notifies voice application server 1603 via network server-to-server connection and instructs the application server to initiate an outbound telephony call to the user's computer thus activating a ringing event on the user's telephony software. Both of these connection types may be bridged between the PSTN and Internet networks as illustrated above. In the event that an outbound call is used, the notification to the application server includes the IP telephony number assigned to the computer hosting the telephony software. If the call is initiated from the client then the user number is not required.

Incoming event 1601 includes data aggregated by an application program server interface (APSI) analogous to APSI 1529 or APSI instances 1535 and 1536. This data includes, of course, the data associated with the enterprise advertisement like the enterprise contact number to portal 1602, the keyword or phrase set the advertisement is associated with in configuration, and the advertisement identification. Other data sent with the call may include user IP address, user contact telephone number, and the exact keywords or phrase used that triggered delivery of the enterprise advertisement. The data just described is represented in system 1600 as APSI data 1607. The voice portal in this case, is the first system component in system 1600 to receive APSI data, however this is not specifically required to practice the present invention. In one embodiment, application server 1603 may be the first component to receive the data.

Voice portal 1602 passes the APSI data over to server 1603, which has an enterprise/advertisement matching service block 1613. Block 1613 receives the advertisement identification and/or destination number identification called and uses it to locate the specific enterprise skin (in the case of multiple tenancy) from a pool of enterprise skins illustrated herein as enterprise skins 1604 wherein skins E1 through En reside for selection and service. The enterprise skin corresponding to event 1601 is served to portal 1608 and is executed for presentment to the caller over the voice connection established. In the case of multiple tenancies, core voice application logic 1617 within voice application server is the base logic over which all enterprise-specific function is built upon. In this case, the core logic is available to all of the enterprise tenants.

Enterprise skin 1608 includes a speech application 1611, which includes the enterprise-specific voice application logic used to interact with the caller. Speech application 1611 is executed and an interaction flow, illustrated herein as interaction flow 1609 begins. Interaction flow id defined herein as voice interaction between the caller and the system. Matching service 1613 shares APSI data with a dialog/AD selection engine 1615 contained within an application runtime engine 1614. Runtime engine 1614 is responsible in this case for driving and monitoring the ongoing interaction flow 1609.

Interaction flow 1609 comprises dialogs presented to the caller and interpretations of the callers voice responses. Therefore, at some point in the interaction, a vacant advertisement slot in the speech application is marked for advertisement fulfillment. Dialog/AD selection engine 1615 uses, in this case, the actual keywords or phraseology passed to it by service block 1613 to perform a sorting and selection operation with respect to an advertisement pool 1606 containing AD 1 through AD n. Advertisements residing in pool 1606 all are associated with specific keywords and or phraseology as described further above. Therefore, the advertisement that most closely matches the exact keywords and or phraseology input by the user in the search engine before the enterprise advertisement was served and selected by the user is selected for service into the interaction flow of speech application 1611.

Certain information may be already pre-known to system 1600 before advertisement matching and delivery occurs. For example, the only advertisements considered for service might be those pre-approved by the enterprise for publishing. If the enterprise has more than one speech application then simple content relevancy comparison may further narrow the advertisement pool before a keyword or phraseology match is performed. The advertisement that prevails for placement is retrieved from pool 1606 and placed within speech application 1611 for incorporation into interaction flow 1609 for presentment. The prevailing advertisement is illustrated in this example as dynamic advertisement 1610 waiting for incorporation into interaction flow 1609. The advertisement may be a dialog containing one or more interactive options that the user might select to cause fulfillment of the advertisement goal. Likewise, the advertisement may be a simple reference advertisement that is played but may not be interacted with.

Runtime engine 1614 monitors enterprise skin 1608 and speech application 1611, including interaction flow 1609. Therefore, a profiling and behavioral engine 1616 illustrated within runtime engine 1614 may obtain and analyze real-time data about the caller and the caller's interactions with speech application 1611. Optionally, result values obtained through analyzing the caller's interaction activity, sensed mood, or other information that may be pre-known about the caller (caller history, profile, etc.) may be added to the process of selecting an advertisement for service in addition to keyword and phrase matching. However, this is not required in order to practice the invention.

In one embodiment, data passed to selection engine 1615 by service block 1613 may be used for the purpose of selecting dialog options for presentment into interaction flow 1609 of speech application 1611 in the same way that the process works for advertisement selection. For example, the enterprise associates various dialog options, illustrated in this example as dialog options 1605 (including options D1 through Dn), of a speech application to keywords and or phraseology a user may enter into a search engine to receive content-relative results just as the advertisers do when submitting their ads for voice application placement. Therefore, both dynamic advertisement service and dynamic interaction dialog service may be practiced at the same time without departing from the spirit and scope of the invention.

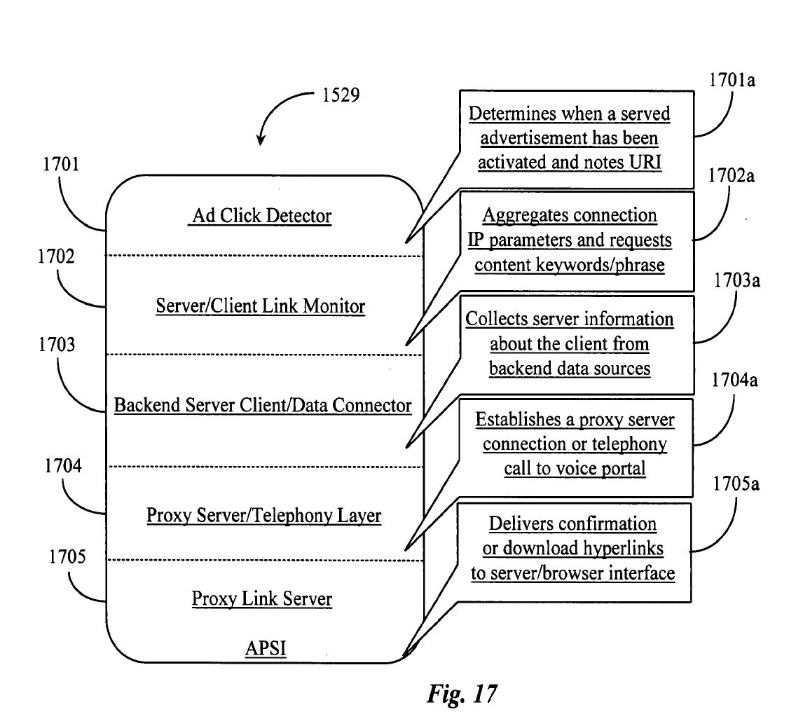

FIG. 17 is a block diagram illustrating components of application program server interface 1529 of FIG. 15 according to an embodiment of the present invention. Interface 1529 includes an Ad-click detector module 1701 that determines, as illustrated in information block 1701a, when an advertisement served in a search engine result page (search engine embodiment) has been activated by a user and notes the universal resource indicator of the served advertisement and any other pertinent data. The advertisement is a voice link, in this embodiment, to a voice application. In one embodiment, APSI 1529 also notes when an advertisement is served whether or not a potential customer has activated it. When a customer activates a served advertisement, such as by clicking on it with a pointer device, a voice connection between the customer and the voice application interface is established. This may be accomplished in a number of ways using telephony and/or IP protocols.

In one embodiment, the link sends a destination number to the customer's resident IP telephony application running on the customer computer. When the application receives the number it dials the number and the customer, using a headset, is connected to the voice application interface through a telephony bridge. In another example, the link establishes a server-to-server connection between the provider server and a voice application server associated with the voice interface portal. The customer's telephone number and other pertinent APSI-collected data may be sent over the server link to the voice application server whereupon receiving the data, the server may instruct the voice portal to place an outbound call to the specified customer device. In still another example, the voice portal has an IP telephony voice interface accessible from a computer without requiring any standard switched telephony hardware or software. Depending on implementation and level of third-party involvement of the search provider, a customer may have certain connection preferences for voice interaction.

APSI 1529 includes a server/client link monitor 1702. Monitor 1702 aggregates, as illustrated in information block 1702a, connection IP parameters and requests the content keywords and or phrasing used in the search that produced the advertisement. These keywords and/or phrases are passed along to the voice application interface with the call established as a result of interaction with the advertisement. The aggregated connection parameters may include the customers IP address, the provider server IP address, the customer session number, active port identification and so on. The connection data may be useful at the voice application end of any established connection for the purpose of initiating a server-to-server connection ultimately back to the customer for delivering any confirmation data or for serving hyperlinks to media for download by the customer.

APSI 1529 also includes a backend server client/data connector 1703. Connector 1703 collects, as illustrated in information block 1703a, server information that may exist about the client from any backend data sources maintained at the server. This data may include alternate contact information such as email address, telephone number, instant message identification, cellular telephone number, address and the like. Depending on the nature of the search environment, backend data may also include client parameters like purchase history, site navigation history, and the like. Information such as a customer's telephone number may enable the voice application interface to initiate an outbound telephone call to the client on a device separate from the client computer used to activate the advertisement. Likewise information about a customer's mobile device may enable content delivery, if any, resulting from a transaction to the customer's mobile telephone rather than back to the customer's computer interface. Historical or statistical data that may be known about the customer at the point of the provider's server may be used at the voice application server to further tune voice application interaction more toward the customer's needs.

APSI 1529 contains a proxy server/telephony layer 1704 adapted, as illustrated in information block 1704a, to establish a proxy server connection or a telephony call to the voice portal addressed in the advertisement data. For example, if the client has an IP telephony application on his or her computer, layer 1704 may establish a connection to the voice portal interface number and then call the clients IP telephony software to connect the call. In one embodiment, the advertisement specifies a server-to-server link whereupon once established causes generation of an outbound telephone call to the client's telephone number if known. In still another embodiment, an IP version of voice interface may be interacted with simply using a server link.

APSI 1529 may include, in one embodiment, a proxy back link server 1705 that may operate through a data link established between the search provider server and the voice application server when a client is interacting with the voice application. Server 1705 is adapted according to information block 1705a, to deliver any transaction-related confirmation or, in one embodiment, hyperlinks for downloading media to the provider's server and to the customers browser interface. If the APSI data includes a customer computer address then a back link may be initiated from the voice application server directly to the client's browser application.

It will be apparent to one with skill in the art that APSI 1529 may be provided with fewer components than are illustrated in this example without departing from the spirit and scope of the present invention. For example, in a simple embodiment, modules 1705 and 1703 are not required. In a simple embodiment, the only requirement is that when a customer clicks on an advertisement, a telephone link is established between the client and the voice application. The associated data embedded in the advertisement provides the destination number and the identification of the enterprise associated with the advertisement in the case of a multiple tenant voice interaction service. There may be more than one destination number used in association with the advertisements, for example, each enterprise may have its own voice application telephone number. Also in a simple embodiment, only the keywords used to invoke service of an advertisement are may be passed to the voice application server so that they may be used to tune the voice application presentation with respect to dialog options and published third-party advertisements presented through the voice application to the customer.

The exact mechanics of connecting the customer to the voice application over a network path that supports voice calls may vary according to existing possibilities. For example, a telephone-to-telephone call may be established using inbound or outbound techniques. The intermediary server may initiate the call and then connect either party once the other has picked up. Likewise, a computer-to-telephone call may be established, the call bridged between the Internet and the PSTN networks. Still possible, although not preferred, is a point-to-point data connection that supports bi-directional voice interaction. There are many possibilities.

In yet a further embodiment, ASPI 1529 may be provided as a client application downloaded and installed on the client's desktop or other computing device used to access search engine services. In this embodiment, the interface collects the keywords input into the search engine interface as they are entered by the user and packages that data for send at the time of a voice link, which ay also be implemented by the interface on the user's local device.

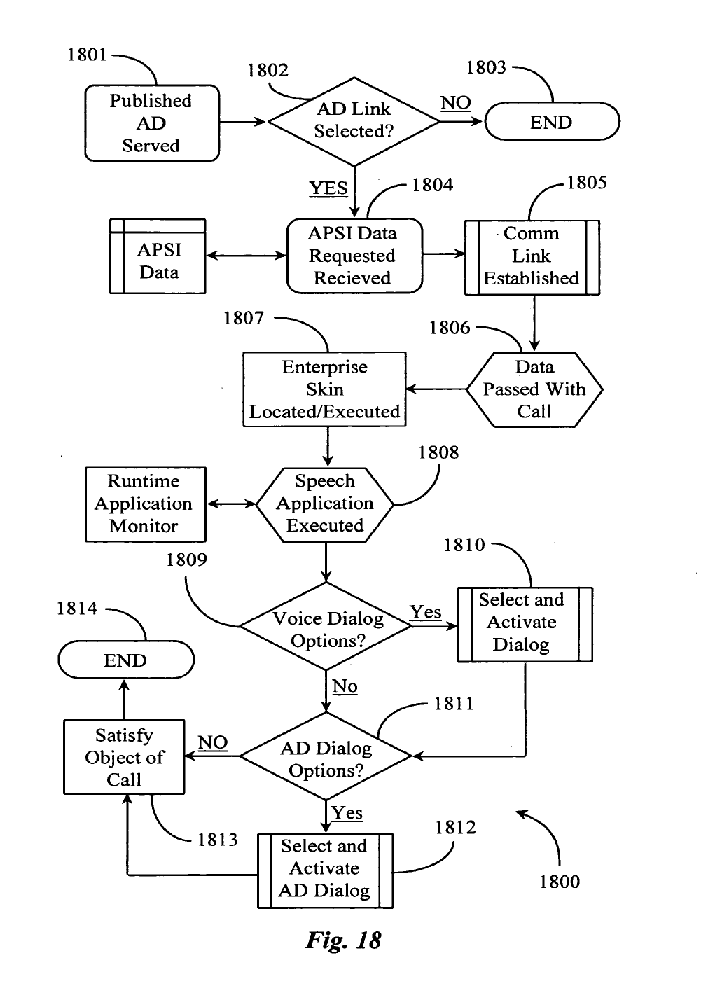

FIG. 18 is a process flow chart illustrating steps for linking a potential customer to a voice application and serving one or more dynamic dialogs to the customer through the application according to an embodiment of the present invention. At step 1801, an advertisement published by an enterprise hosting a voice application is served. In this step, the advertisement may be served to a search result page in an advertisement space reserved for the purpose. The advertisement is served, in a preferred embodiment, because the keywords or phrase used by the potential customer in the search engine matched those associated with the advertisement by the enterprise publisher of the advertisement. In one embodiment, the intermediary server that served the advertisement into the search result page may log service of the advertisement and make a record of the service accessible to the enterprise that authored the advertisement.

At step 1802, the potential customer might select the advertisement served in step 1801. If the advertisement is not selected, then in step 1803 the process ends until the advertisement is again served. If at step 1802, the potential customer selects the advertisement, then at step 1804, the APSI data is requested and received. In this step, the APSI requests and receives the keyword and/or phrase data that the potential customer input into a search engine to obtain the result page within which the advertisement was served. APSI data is not specifically limited to the search engine input data that drew service of the advertisement. In addition to that data, other types of server data about the potential customer may be included without departing from the spirit and scope of the present invention such as connection data defining the connection between the potential customer and the server, client information such as contact information and preferences, navigation histories, purchase histories and so on. Alternate contact information may help in establishing an outbound call in one embodiment. IP information may help in establishing a back link.

At step 1805, a communication link (voice link) is established between a the potential customer and a voice interface hosted by or otherwise reserved for the enterprise responsible for the advertisement that was invoked at step 1802. In one embodiment, the intermediary server brokers the voice connection between the potential customer and the voice interface using a telephony application that calls both parties and then connects the call legs to establish the connection. In this embodiment, the voice call ultimately established may be a pure telephone call using a cost oriented switched telephony network connection. In one embodiment, the voice connection is ordered on behalf of the potential customer by first opening a server-to-server connection to a voice application server associated with the voice interface and then instructing the voice interface to establish an outbound telephone call to the potential customer using data received over the first link. This outbound call may be placed to the customers IP telephony application, or it may be placed to a known device used by the customer. Likewise, there are other possible ways to establish the voice connection between the potential customer and the voice interface.

At step 1806, data received by the APSI at step 1804 is passed ahead of or with the voice call. In a preferred embodiment, the data includes the exact search engine input the potential customer used to invoke the advertisement. It is noted herein that the keywords or phrases associated with the advertisement may not all be exactly or even closely related to the exact search terms used to invoke the advertisement. In service of the advertisement, all that is required is that at least one term used in the search matches one term associated with the advertisement.

At step 1807, in the case of a multiple tenant service, the enterprise skin of the enterprise hosting the advertisement selected in step 1802 is located and executed. The voice application server of a multiple tenant service may perform this step after the call is connected. The enterprise skin may be identified using data passed with the call and data about the call including the destination number used if the call is incoming. The enterprise skin contains, in a multiple tenant service embodiment, the enterprise specific functionality that may be run over core voice application logic. In the case of a single tenant application, step 1807 is not required.

At step 1808, the speech application of the enterprise servicing the advertisement is executed or launched. If it is already running and servicing clients then the caller may be queued to join the application, or may be connected to the application at the appropriate start point at any time there is a vacancy. A runtime application monitor analogous, in this example to runtime engine 1614 of FIG. 16 monitors the state of the connection and application progress with the caller.

At step 1809, it is determined whether there are any dynamic voice dialog options that may be selected based on information about the caller. It may be that there are no dynamic voice dialog options for the particular speech application. In this case, it is determined at step 1811 whether or not there are any ad dialog options. At step 1809, if the system determines that there are voice dialog options, then at step 1810, the system selects and activates the appropriate dialog for the position of the caller and based on information about the caller. In either case of step 1809, the system determines if there are any ad dialog options at step 1811.

It is possible at step 1811, that there are no ad dialog options. This might occur if there is only one advertisement available for a specific advertisement slot in a speech application dialog. At step 1811, if there are no dynamic ad dialog options, then at step 1813, the system attempts to satisfy the object of the call, and the caller is disposed of at step 1814. In this case, the user interaction with the original advertisement triggered a specific speech application that already has the appropriate advertisement or advertisements designated for service.

If at step 1811, there are ad dialog options available, then the system, at step 1812, selects and activates an ad dialog from a pool of ad dialogs competing for placement through the speech application. The ads contained in the pool might be third-party ads, which the host has agreed to consider for placement. The winning ad dialog for placement in an ad vacancy reserved in the speech application is, in a preferred embodiment, one that most closely matches the exact keyword, keywords, or phrase input by the caller into the search interface to bring up the sponsored advertisement that the caller then subsequently interacted with to cause initiation of the connection with the voice interface. In another embodiment, the competing advertisement dialogs may all be enterprise advertisements for products offered through the enterprise, which may be a large retailer, for example.

In one embodiment, additional criteria (in addition to keywords) may be used by the system, more specifically by the ad selection engine 1615 described further above, to determine an ad for any given ad vacancy in the speech application. For example, a competing ad dialog may win placement via keyword relevancy, but may be overridden for placement by another less relevant advertisement if, for example, information about the caller indicates the less keyword-relevant advertisement shows more relevancy toward statistics about the caller.

To illustrate an example, consider that a user has entered “pet products” into a search engine interface, which brings up an enterprise advertisement to a large pet retailer. An ad dialog “Would you like to hear about our newest bird products?” may be the ad dialog that wins the keyword match. However, it may be known that the caller is a reptile enthusiast and has a history of buying snakes from the retailer. In this case, the ad dialog winning the keyword match may be overridden by an ad “Would you like to hear about our new snake arrivals? In one embodiment, a combination of keyword or phrase matching and consideration of what is known about a caller is combined when selecting an appropriate advertisement for placement into an ad vacancy in a speech application servicing the caller. This may be beneficial in some embodiments where a user enters relatively broad search terms, but is actually seeking a product or service that could be more narrowly defined.

At step 1813, the system attempts to satisfy the object of the call, which may be borne out through caller interaction with the advertisement dialog activated at step 1812. Step 1813 may include further dialog options for completing a transaction related to the advertisement dialog activated. The nature of such transaction dialog may vary according to design. For example, if the advertised product or service is hosted by and available through the enterprise, then the transaction dialog may include that for accepting payment, concluding the transaction and tasks for confirming the transaction. If the advertisement is a third-party advertisement, then the transaction dialog may simply be an issuance of a confirmation code or the like for a discount or in some cases an agreement to send the caller a coupon, link, or other indication of business confirmed.

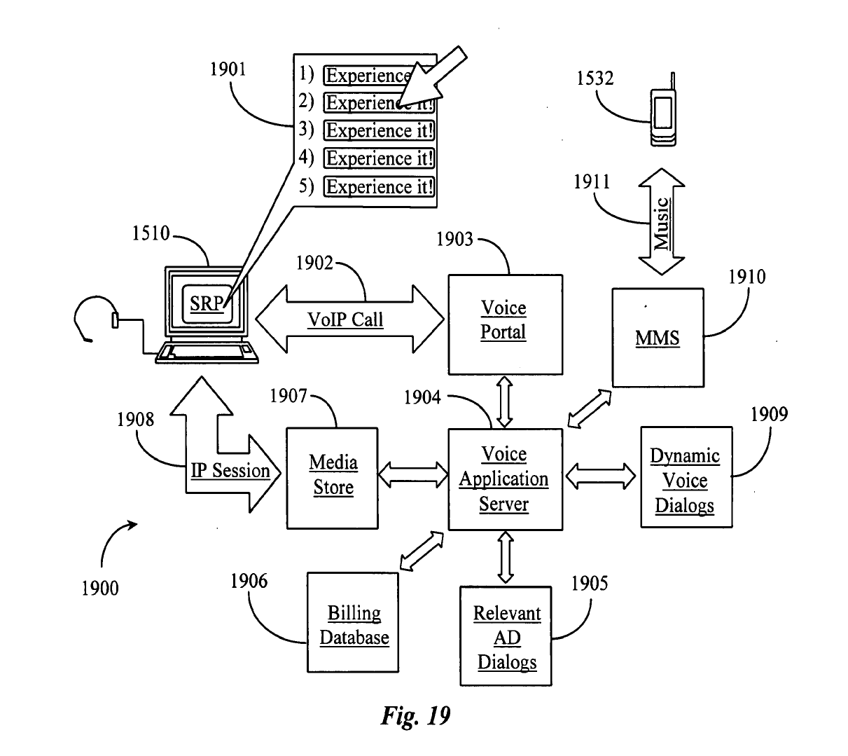

FIG. 19 is a block diagram 1900 illustrating a process for linking a potential customer 1510 to a voice application system according to another embodiment of the present invention. Potential customer 1510, described further above with reference to FIG. 15 is assumed online and engaged with an enterprise hosting a music service or online media storefront, illustrated herein as media store 1907 over a typical IP session 1908. In this embodiment, customer 1510 has entered keywords and or phrasing to initiate electronic return of a search result page (SRP) 1901.

SRP 1901 lists several media choices (numbered 1-5), which may be references to music samples or clips that are relevant to the keywords or phrase used in the search. For example, customer 1510 may have entered the name of a favorite band resulting in several links to music samples of music authored by the band and that the enterprise offers for sale as single complete songs that are downloadable. The links may also be to music samples that are part of an album or CD offered for sale by the enterprise. In this example, each listed result includes an interactive icon labeled “Experience it!”. The icons are, in a preferred example, telephony or VoIP links to a voice portal 1903. In the case of VoIP, interaction of any of the returned results (clicking on Experience it!) initiates a VoIP call 1902 to voice portal 1903 through a VoIP gateway (not illustrated). VoIP call 1902 may be initiated and may use a telephony application installed o the station of customer 1510. At this time, IP session 1908 is not interrupted.

At voice portal 1903, the caller is identified and the keywords or phrasing used to return SRP 1901 are collected (passed with the call). Though each interactive result may reference a different music sample of the same artist, the destination number used to connect to portal 1903 may be the same for all of the returned results. That is to say that instead of downloading sample clips as is the usual practice for online media storefronts, the method of the present invention connects the customer to a voice portal where the actual audio samples may be presented over a connection other than the original IP session.

Voice portal 1903 accesses a voice application server 1904 to connect the caller to the appropriate speech application. The voice application server 1904 then serves the appropriate voice application, which may be a generic application containing slots or vacancies to be filled with, for example, the appropriate music samples ordered by the user. During interaction with the caller, the speech application runtime engine selects the appropriate dynamic voice dialogs for service from a dialog pool 1909. For example, if the user entered the keywords “Herbert Laws”, then a dialog appropriate for a customer looking for “Smooth Jazz” may be executed. In addition, the voice dialog selected may have a slot for presenting the specific music sample clip referenced in the call link that the user interacted with to initiate the call. The correct clip may be retrieved from media store 1907, or some other local database, and inserted into the dialog slot or vacancy. After presenting the clip, additional dialogs may be presented to enable the customer to by the clip, the album associated with the clip, or to hear another relevant clip.

If customer 1510 agrees to buy the song or electronic CD, for example, a download link may be sent from the media store back to the customer over existing open session 1908. Such a link may appear in the customers browser interface. If a customer does not agree to purchase a sampled clip or simply does not like the clip, a dynamic dialog from pool 1909 may be presented that has one or more vacancies for inserting other relevant clips including voice options for the customer to direct purchase or no of each selection represented by the sample presented.

In one embodiment, voice application server 1904 may, according to customer direction enabled through interactive dialog, send any purchased media to a device other than the computer used by customer 1510 to interact. In this case, the media purchase may be forwarded through a multi media service gateway 1910 over a wireless telephony link 1911 to smart phone 1532 also described further above with reference to FIG. 15. In this case, link 1911 caries digital music to device 1532. However, any type of purchased media, for example, video, text, or software may be forwarded to device 1532.

Application server 1904 may also be adapted to log transaction activity including generation of billing data, which may be stored in a billing database 1906. Database 1906 may hold customer account data, transaction histories, contact information for other devices like device 1532 and so on. In this example, third-party advertisers may also submit advertisements for presentment into a speech application served by application server 1904. Relevant ad dialogs may be contained in a pool 1905 for selection retrieval and presentment into available advertisement slots contained in voice dialogs presented to the customer. For example, a relevant ad in the case of a music store might be discount concert ticket or tickets to see the band live at a local upcoming concert date. Therefore, if the customer typed in Herbert Laws and clicked on a returned sampling link (Experience it) then an ad dialog may be presented that informs the customer if a CD containing the sampled clip is purchased, then a confirmation number that may be used to claim 2 discounted tickets to a Herbert Laws concert might be sent to the customer in email or some other messaging conduit. The third party advertisement matches the keywords Herbert Laws typed into the interface and therefore is selected from other advertisements in the pool.

In one embodiment, third-party advertisers may simply provide relevant advertisements for placement wherein those advertisements are selected as a direct result of customer interaction results related to sampling and purchasing music. For example, several third-party ads may be broadly related to the blues genre, for example tickets to different blues events, however as the customer interacts further drilling down to a particular artist, then the ads most relevant to that artist would be left on the table for consideration of placement. Likely, only one remaining ad would be directly relevant to a customers purchase.

Ad dialogs may be selected according to keyword relevancy in combination with customer interaction choices to narrow selection options for presentment. For example, 3 advertisements may be related to blues in general, and be further granulated to a specific band or artist that may only become known through customer interaction with the voice application. There are many possibilities.

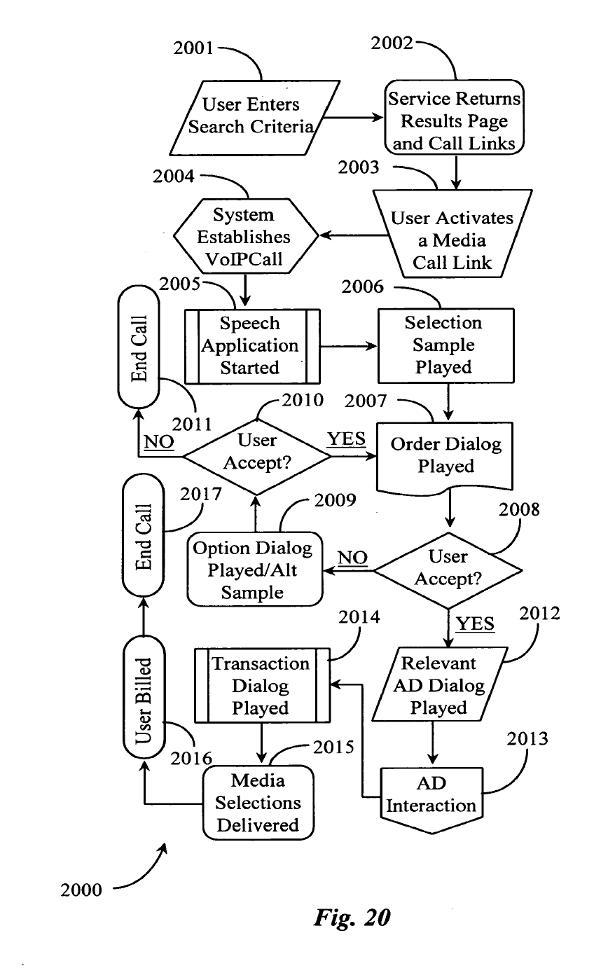

FIG. 20 is a process flow chart 2000 illustrating steps for fulfilling a customer music order using the system of FIG. 19. At step 2001, a user enters search criteria in a provided media search interface, for example, at an online media storefront. At step 2001, the service returns a results page and associated call links. For example, if the user at step 2001 enters the keywords blues, then various references to music samples of the blues genre may be returned, each reference associated with a call link. It is noted herein that the music reference is not a hyperlink to a sample for download, but rather just an identification of a sample that may be presented through a speech application if the associated call link is activated establishing a voice connection between the user and a service voice interface. It is also noted herein that the referenced telephone number or destination address of the voice interface may be the same for each of the returned call links if one interface is available and services all customers of the enterprise. However, there may be more than one destination number or identification used for different purposes of the enterprise. For example, different numbers may apply to different music categories, and so on. A multi-tenant embodiment may also be realized wherein the storefront is shared by more than one music provider.

At step 2003 the user of step 2001 activates a media call link to sample a selection offered as a search returned result. At step 2004, the server establishes a VoIP voice call to an enterprise hosted voice interface analogous to voice portal 1903. This step may be accomplished using a telephony application available on the user's desktop. In one embodiment, the connection may be established as an outbound call to the user from the voice portal.

At step 2005, a speech application is started and at step 2006 the selected music sample is played for the user. After the sample plays, at step 2007, an order dialog is played enabling the user to express whether he or she might agree to purchase the offering relevant to the played sample and whether the user is willing to listen to an advertisement that might be related to a purchase of the offering. The offering may be a complete selection like an MP3 file, or the offering may include a group of selection comprising an electronic CD or album. At step 2007, part of the dialog may include a solicitation of the user to accept an advertisement. If the user does not agree, and does not want to purchase the music related to the sample played, then at step 2009, an option dialog may be played providing an alternate, but related music sample for the user to listen to.

At step 2010, it is determined whether the user will accept an offering related to the alternate sample played. If the user chooses no, then the call may be terminated. In one embodiment, more than one sample may be played for the user after each presentation, the user may be given the option to purchase, not to purchase, or to listen to yet another sample. At step 2008, if the user accepts the selection sampled at step 2006, then step 2012, a relevant ad dialog may be played for the user. If the user continues to cooperate, then at step 2013 the user may interact with the advertisement using an ad interaction dialog. The ad interaction dialog may simply provide the user with a confirmation of some discount on a related product or service that the user may redeem at a later time. An example might be a reference code for obtaining a discount on concert tickets to an upcoming event including the artist whose music offering the user agreed to purchase.

At step 2014, a transaction dialog is played enabling an online voice transaction authorizing the purchase and delivery of the related offering. At step 2015, the particular media selection or selections comprising the offering may be delivered to the user electronically such as in a download, or over a media channel to another user device like a smart phone. After the transaction, the user may be billed at step 2016. This may include debiting user tokens pre-purchased for buying music from the service. In one embodiment, a user is electronically billed to a credit card or to some other account the user has pre-authorized access to. There are many possibilities. At step 2017, the call may be terminated.

At step 2010, if the user accepts one of the alternate samples played, at step 2007 the order dialog is played to determine if the user will entertain an advertisement. If the user accepts at step 2008 then steps 2012 through 2017 may be repeated. One with skill in the art of transactional processes will conclude that the exact order and content of the dialogs relating to ad service and the purchase of any offerings may be changed in order in this process without departing from the spirit and scope of the present invention. For example, a solicitation for an advertisement may be presented in a dialog before a user is presented the music sample. In another embodiment, a solicitation for an advertisement may be presented after a user has purchased a music offering. In one embodiment, a user has the option of accepting the solicitation and therefore agreeing to hear an advertisement. In another embodiment however, an advertisement dialog may be selected and presented to a user by default. There are many variants to the process that may be practiced depending on the situation.

In one embodiment, the data passed with the initial VoIP call from the server interface includes identification of some of or all of the media samples referenced in the search results. In this embodiment, instead of ending the call in the event a user does not like the first sample played, the other samples may be navigated to via the voice application instead via the user's browser interface. There are many possibilities.

One with skill in the art will appreciate that the methods and apparatus of the present invention can be applied to variant environments without departing from the spirit and scope of the present invention. In one embodiment, call links are served as sponsored ads n a public search engine results page. In another embodiment, call links are served as results, each result in a list of results including the instruction and data for the server to initiate a VoIP call or even an outbound telephony call back to the user, the call placed from the voice portal. Ad dialog options may include entire voice dialogs, or generic voice dialogs having ad slots for inserting certain synthesized voice. An example of such a dialog might be “Would you be interested in discount tickets to ______ playing at ______ on ______?” wherein the first slot is a band name, the second slot is the concert location, and the last slot is the date and time of the concert. In this way different ads for the different concerts may be constructed in near real time as the user interacts with the system.

The methods and apparatus of the present invention may be practiced over the Internet including any sub-networks connected thereto and a telephony network capable of accepting calls initiated from a data packet network. In some embodiments, outbound telephony calls may be ordered to be placed from a voice interface to a device specified by the user other than the computing device used to initiate a connection, such as for example to a smart cellular telephone. Likewise a telephone capable of simultaneous IP and voice sessions may be used as the originating and receiving device.

What is claimed is:

1. A system for dynamic advertisement selection and presentment within a speech application comprising:
a user operable network-browsing interface in communication with a server on a data network;
at least one voice link to a voice application interface, the link or links accessible to the user working within the browsing interface;
a pool of at least one advertisement for presentment; and
a selection engine accessible to the voice application interface for receiving criteria originated from the server for advertisement ranking and for selecting an advertisement from the pool of at least one advertisement for placement based on the received criteria.
